(19) United States
(12) Patent Application Publication
(10) Pub. No.: US 2018/0181889 A1
(43) Pub. Date: Jun. 28, 2018

(54) SYSTEMS AND METHODS FOR FORMULATION OF EXPERIMENTS FOR ANALYSIS OF PROCESS PERFORMANCE

(71) Applicant: RIFFYN , INC., Oakland, CA (US)

(72) Inventors: Timothy S. GARDNER, Oakland, CA (US); Matthew W. PERCIVAL, Berkeley, CA (US)

(73) Assignee: RIFFYB ,INC.

(21) Appl. No.: 15/739,561

(22) PCT Filed: Jun. 24, 2016
(86) PCT No.: PCT/US2016/039227

§ 371 Date: Dec. 22, 2017

Related U.S. Application Data
(60) Provisional application No. 62/184,556, filed on Jun. 25, 2015.

(51) Int. Cl. G06Q 10/06; G06F 8/10; G06F 17/18; G06N 5/02; G06F 17/50; G06F 8/34

(52) U.S. Cl. CPC G06Q 10/063; G06F 8/10; G06F 8/34; G06N 5/022; G06F 17/50; G06F 17/18

(57) ABSTRACT

Systems and methods for building a run hypergraph for a process from parameter combinations subject to run constraints are provided. The run hypergraph comprises a plurality of nodes, and runs associated with nodes, each run comprising a run identifier and a parameter combination identifier. A process hypergraph comprising the nodes connected by process edges is obtained. Each edge specifies resource outputs of a parent node included in resource inputs of a child node. A plurality of factors and parameter combinations are identified. Each factor is associated with an input or output property of a resource input or output of a node, with a number of levels. Each parameter combination includes an instance of the factors, and for each factor, an associated property level. Each run constraint specifies a relationship between a number of runs of the parent and the child for a corresponding parent/child node pair.

### CROSS REFERENCE TO RELATED APPLICATION

This application claims priority to U.S. Provisional Application No. 62/184,556, filed Jun. 25, 2015, entitled “Computer-Implemented Method for Recording and Analyzing Scientific Test Procedures and Data,” which is hereby incorporated by reference.

### TECHNICAL FIELD

The present disclosure relates generally to systems and methods for design of processes that result in analytical information or products.

### BACKGROUND

Multi-stage processes are relied upon in the research and manufacture of a wide range of products including biologics, pharmaceuticals, mechanical devices, electrical devices, and food, to name a few examples. Unfortunately, such processes typically have many sources of variation. While most of these sources are minor and may be ignored, the dominant sources of variation may adversely affect the efficiency or even viability of such processes. If identified, however, resources to remove these dominant sources of variation can be engaged and, potentially, such dominant sources of variation can be removed, minimized or contained. Once these dominant sources of variation are addressed, a process may be considered stabilized. When a process is stable, its variation should remain within a known set of limits. That is, at least, until another assignable source of variation occurs. For example, a laundry soap packaging line may be designed to fill each laundry soap box with fourteen ounces of laundry soap. Some boxes will have slightly more than fourteen ounces, and some will have slightly less. When the package weights are measured, the data will demonstrate a distribution of net weights. If the production process, its inputs, or its environment (for example, the machines on the line) change, the distribution of the data will change. For example, as the cams and pulleys of the machinery wear, the laundry soap filling machine may put more than the specified amount of soap into each box. Although this might benefit the customer, from the manufacturer's point of view, this is wasteful and increases the cost of production. If the manufacturer finds the change and its source in a timely manner, the change can be corrected (for example, the cams and pulleys replaced),

While identification of variation of processes is nice in theory, in practice there are many barriers to finding such variation. Most processes combine many different functional components each with their own data forms and types of errors. For instance, a process for manufacturing a synthetic compound using a cell culture combines chemical components, biological components, fermentation components, and industrial equipment components. Each of these components involves different units of quantification, measurement, and error. As such, the rate-limiting step for developing and stabilizing processes is not development of the algorithms that are used in such processes; it is the acquisition and contextualizing of the data in such processes. This requires data aggregation and reproducibility assessment across many disparate systems and functionalities so that scientific reasoning is based on reproducible data rather than on artifacts of noise and uncertainty. Conventional systems fail to deliver adequate capabilities for such analysis. They focus on storing files and data without providing the structure, context or flexibility to enable real-time analytics and feedback to the user.

For instance, electronic lab notebooks (ELNs) are basically “paper on glass” and have inadequate ability to streamline longitudinal analytics across studies. Lab information management systems (LIMS) focus on sample data collection, but don't provide the process or study context to facilitate analytics, nor the flexibility to adapt to changing workflows “on-the-fly” and the many disparate functionalities that are often found in processes. Thus the relationship between process and outcome remains unclear or even inaccessible and information systems become “dead” archives of old work mandated by institutional policies rather than assets that drive process stabilization.

As a result, billions of dollars are lost each year on material and life science research that are not stabilized and thus have unsatisfactory reproducibility rates. Moreover, the incidence of multi-million dollar failures during process transfer to manufacturing remains high.

Another obstacle for such processes are providing systematic methods to determine the relationship between factors affecting a process and the output of that process. In other words, finding cause-and-effect relationships. Such information is needed to manage process inputs in order to optimize the output.

Thus, given the above background, what is needed in the art are improved systems and methods for formulation of experiments to identify sources and causes of variation.

### SUMMARY

The disclosed embodiments address the need in the art for improved systems and methods for the formulation of experiments to identify sources and causes of variation in processes that result in analytical information or products. The disclosed embodiments address this need by building a run hypergraph from a plurality of parameter combinations for a process subject to a plurality of run constraints for the process As used herein the term “product” refers to, for example, tangible products such as materials, compositions, ingredients, medicines, bulk materials, and the like; and the term “analytical information” refers to, for example, categorical or quantitative data describing measurements of materials, equipment, or process settings. The disclosed systems and methods advantageously and uniquely provides systems and methods for designing a set of runs for a process that will adequately determine the relationship between factors affecting the process and the output of the process.

One aspect of the present disclosure provides a non-transitory computer readable storage medium for building a run hypergraph from a plurality of parameter combinations for a process subject to a plurality of run constraints for the process. The run hypergraph comprises (i) a plurality of nodes, (ii) a plurality of runs, each run in the plurality of runs being associated with a node in the plurality of nodes, and (iii) a plurality of run edges. Each run edge joins (a) a run in the plurality of runs associated with a parent node in the plurality of nodes and (b) a run in the plurality of runs associated with a child node in the plurality of nodes. The process results in a product or analytical information. The non-transitory computer readable storage medium stores instructions, which when executed by a first device, cause the first device to perform a method.

In the method, a process hypergraph for the process is obtained. The process hypergraph comprises the plurality of nodes found in the run hypergraph. In the process hypergraph, these nodes are connected by process edges in a plurality of process edges. Each respective node in the plurality of nodes is associated with a set of parameterized resource inputs to the respective node. At least one parameterized resource input in this set of parameterized resource inputs is associated with one or more input properties, the one or more input properties including an input specification limit. Each respective node in the plurality of nodes is also associated with a set of parameterized resource outputs to the respective node. At least one parameterized resource output in the set of parameterized resource outputs is associated with one or more output properties, the one or more output properties including a corresponding output specification limit.

Each respective process edge in the plurality of process edges of the process hypergraph specifies the set of parameterized resource outputs of a node (parent node) in the plurality of nodes that is included in the set of parameterized resource inputs of at least one other node (child node) in the plurality of nodes and identifies the at least one other node.

In the method, a plurality of factors is identified. Each respective factor in the plurality of factors is associated with (i) an input property in the one or more input properties of a resource input in the set of parameterized resource inputs of a corresponding node in the plurality of nodes or (ii) an output property in the one or more output properties of a resource output in the set of parameterized resource outputs of a corresponding node in the plurality of nodes.

In the method, for each respective factor in the plurality of factors, a number of levels for the input property or output property associated with the respective factor is identified. For example, this may by user specified or read from an input source.

In the method, the plurality of parameter combinations is defined. Each parameter combination in the plurality of parameter combinations is (i) assigned a unique parameter combination identifier from a plurality of unique parameter combinations identifiers, and (ii) includes an instance of each factor in the plurality of factors, where each respective factor in the instance of the plurality of factors is set to a level in the number of levels of the property associated with the respective factor.

In the method, the plurality of run constraints is obtained. Each respective run constraint in the plurality of run constraints corresponds to a different parent node/child node pair in the plurality of nodes that are connected by a process edge in the plurality of process edges. Each respective run constraint in the plurality of run constraints specifies a relationship between a number of runs of the parent node to a number of runs for the child node for the corresponding parent node/child node pair.

In the method, the run hypergraph is build. Each respective run in the plurality of runs of the run hypergraph comprises: (i) an index to a corresponding node in the plurality of nodes, (ii) a run identifier, and (iii) a parameter combination identifier of a parameter combination in the plurality of parameter combinations.

In some embodiments, each respective run in the plurality of runs further comprises (iv) a flag that specifies whether the respective run is marked included, and the building (F) comprises for each respective parameter combination in the plurality of parameter combinations, performing a first enumeration process.

In some embodiments, the first enumeration process comprises adding each node in the plurality of nodes to a first data structure. A first node in the first data structure is removed and used to perform a second enumeration process for the first node when the first data structure is not empty. This processing of removing a first node in the first data structure and using it to perform the second enumeration process is repeated until the first data structure is empty.

In some embodiments, the second enumeration process for the first node comprises adding each parent-child or child-parent node relationship with the first node through a process edge in the plurality of process edges to a parent node-child node connection to a connection data structure. Then, for each respective parent node-child node connection from the connection data structure, the respective parent node-child node connection is removed from the connection data structure and used to perform a third enumeration process for the respective parent node-child node.

In some embodiments, the third enumeration process for the respective parent node-child node connection comprises adding a respective run to the plurality of runs, where the respective run is (i) marked with the identifier for the respective parameter combination, (ii) associated with the parent node, and (iii) includes a level for a factor for the parent node that is specified by the respective parameter combination, when no such run is present in the plurality of runs, where, when such a run is added, the parent node is added back to the first data structure.

In some embodiments, the third enumeration process for the respective parent node-child node connection comprises adding a respective run, to the plurality of runs, where the respective run is (i) marked with the identifier for the respective parameter combination, (ii) associated with the child node, and (iii) includes a level for a factor for the child node that is specified by the respective parameter combination, when no such run is present in the plurality of runs, where, when such a respective run is added, the child node is added to the first data structure.

In some embodiments, the third enumeration process comprises obtaining a subset of runs in the plurality of runs from a bipartite subgraph of the run hypergraph including the parent node and the child node are (i) associated with the parent node and include a level for a factor for the parent node that is specified by the respective parameter combination or (ii) associated with the child node and include a level for a factor for the child node that is specified by the respective parameter combination.

In some embodiments, the third enumeration process is aborted when each run in the subset of runs is marked as “included.” For each respective run in the subset of runs that has not been marked as “included,” a fourth enumeration process is performed.

In some embodiments, the fourth enumeration process for the respective run comprises marking the respective run as “active” and then marking as “active” any run in the subset of runs that are (i) connected to the respective run by a run edge in the plurality of run edges or a combination of run edges in the plurality of edges. The fourth enumeration process continues with the identification within the plurality of runs or adding to the plurality of runs, one or more runs indexed to the parent node or the child node that specifies the level for the factor specified by the respective parameter combination for the respective parent node or child node, when the respective run constraint in the plurality of run constraints between the parent node and the child node is not satisfied by the runs in the plurality of runs that are marked as “active,” thereby satisfying the respective run constraint. The fourth enumeration process continues with marking as “active” these runs that have been newly identified or added, wherein, when runs are added to the parent node or the child node, the parent node or the child node is added back to the first data structure. Further all runs newly identified or added are linked to all parent runs or child runs in the subset of runs that are marked as “active” by assigning each newly identified or added run with a run edge to a parent run or a child run in the subset of runs that is marked as “active.”

The fourth enumeration process continues by marking as “included” all runs in the plurality of runs that are marked “active” and clearing the “active” label from all runs in the plurality of runs.

In some embodiments, the plurality of nodes comprises five or more nodes.

In some embodiments, the set of parameterized resource inputs for a node in the plurality of nodes comprises a first and second parameterized resource input, the first parameterized resource input specifies a first resource and is associated with a first input property, the second parameterized resource input specifies a second resource and is associated with a second input property, and the first input property is different than the second input property.

In some embodiments, the set of parameterized resource inputs for a node in the plurality of nodes comprises a first and second parameterized resource output, the first parameterized resource output specifies a first resource and is associated with a first output property, the second parameterized resource input specifies a second resource and is associated with a second output property, and the first output property is different than the second output property.

In some embodiments, the set of parameterized resource inputs for a node in the plurality of nodes comprises a first parameterized resource input, the first parameterized resource input specifies a first resource and is associated with a first input property and a second input property, where the first input property is different than the second input property.

In some embodiments, the set of parameterized resource inputs for a node in the plurality of nodes comprises a first parameterized resource output, the first parameterized resource output specifies a first resource and is associated with a first output property and a second output property, where the first output property is different than the second output property.

In some embodiments a first input property or a first output property is a viscosity value, a purity value, composition value, a temperature value, a weight value, a mass value, a volume value, or a batch identifier of the first resource.

In some embodiments, the set of parameterized resource inputs for a first node in the plurality of nodes comprises a first parameterized resource input, and an input property associated with the first parameterized resource input specifies a process condition associated with the corresponding node. In some such embodiments, the process condition comprises an intensive quantity, an extensive quantity, a temperature, a volume, time, a space, a quality, a type of equipment, an order, a state, or a batch identifier.

In some embodiments, the set of parameterized resource outputs for a first node in the plurality of nodes comprises a first parameterized resource output, and an output property associated with the first parameterized resource output specifies a process condition associated with the corresponding node. In some such embodiments, the process condition comprises an intensive quantity, an extensive quantity, a temperature, a volume, time, a space, a quality, a type of equipment, an order, a state, or a batch identifier.

In some embodiments, the corresponding output specification limit comprises a nominal value, an upper limit or a lower limit for an output property of a corresponding parameterized resource output.

In some embodiments, the corresponding output specification limit comprises an enumerated list of allowable types or states.

In some embodiments, a factor in the plurality of factors is a continuous factor, a discrete numeric factor, or a categorical factor.

In some embodiments, the defining of the plurality of parameter combinations implements a full factorial design of the plurality of factors to define the plurality of parameter combinations, where the plurality of parameter combinations collectively defines, for each respective factor in the plurality of factors, the specified number of levels of the specified property associated with the respective factor.

In some embodiments, the defining of the plurality of parameter combinations implements a fractional factorial design (e.g., Taguchi design or a Latin Squares design) of the plurality of factors to define the plurality of parameter combinations, where the plurality of parameter combinations collectively defines, for each respective factor in at least a subset of the plurality of factors, a subset of the levels of the specified property associated with the respective factor.

In some embodiments, the defining of the plurality of parameter combinations implements a D-optimal or I-optimal design algorithm (e.g., a Fedorov algorithm) to define the plurality of parameter combinations.

In some embodiments, the defining of the plurality of parameter combinations requires repeating the defining until an exit condition is satisfied. Examples of an exit condition include user acceptance of the plurality of parameter combinations, or a power calculation based upon the plurality of parameter combinations satisfying a first threshold level (e.g., at least eighty percent, at least ninety percent, at least 99 percent, at least 99.9 percent).

In some embodiments, a first run constraint in the plurality of run constraints is an equality or inequality property imposed between the output of the parent node and the input of the child node in the parent node/child node pair associated with the first run constraint.

In some embodiments, a first run constraint in the plurality of run constraints is a mass balance inequality constraint between the output of the parent node and the input of the child node in the parent node/child node pair associated with the first run constraint.

In some embodiments, a first run constraint in the plurality of run constraints is a one-to-one, many-to-one, or one-to-many relationship between (i) the number of runs of the parent node and (ii) the number of runs for the child node for the corresponding parent node/child node pair.

In some embodiments, the method further comprises adding runs to the plurality of runs prior to building the run hypergraph, where the adding comprises (i) obtaining a set of runs, each run in the set of runs associated with a respective node in the plurality of nodes, (ii) joining a subset of runs in the set of runs, where each run in the subset of runs is linked to at least one other run in the subset of runs by a run edge included in or added to the plurality of run edges, (iii) assigning each run in the subset of runs with the parameter combination identifier of a parameter combination in the plurality of parameter combinations when the subset of runs includes a respective run for each respective factor in the plurality of factors at the respective level specified in the parameter combination for the respective factor, (iv) removing the subset of runs from the set of runs, (v) repeating the obtaining (i), joining (ii), assigning (iii) and removing (iv) until an exit condition is achieved, and (vi) adding each run that has been assigned a parameter combination identifier in the assigning (iii) to the plurality of runs. In some such embodiments, each run in the set of runs specifies a level for a factor for the respective node corresponding to the factor. In some such embodiments, the set of runs are created by a user. In some embodiments, the exit condition is depletion of the set of runs.

In some embodiments, the method further comprises adding runs to the plurality of runs prior to the building the run hypergraph, wherein the adding comprises: (i) obtaining a set of runs, where each run in the set of runs is associated with a respective node in the plurality of nodes, (ii) joining a subset of runs in the set of runs, where each run in the subset of runs is linked to at least one other run in the subset of runs by a run edge included in or added to the plurality of run edges, (iii) removing the subset of runs from the set of runs, (iv) repeating the obtaining (i), joining (ii), and assigning (iii) until an exit condition is achieved, thereby achieving a plurality of subsets of runs, (v) co-clustering each subset of runs in the plurality of subsets of runs that includes a run for each factor in the plurality of factors with the plurality of parameter combinations, where the co-clustering produces a plurality of clusters, and where each cluster in the plurality of clusters includes at most one parameter combinations in the plurality of parameter combinations; (vi) assigning each run in the plurality of subsets of runs that co-clusters with a respective parameter combination the parameter combination identifier assigned to the respective co-clustered parameter combination; and (vii) adding each run that has been assigned a parameter combination identifier in the assigning (vi) to the plurality of runs. In some such embodiments, each run in the set of runs specifies a level for a factor for the respective node corresponding to the factor. In some such embodiments, the set of runs are created by a user. In some such embodiments, the co-clustering is performed by k-means clustering or hierarchical clustering based on a distance metric. In some such embodiments, the distance metric is a Euclidian distance metric, a Hamming distance metric, or a correlation

In some embodiments, the method further comprises pruning the plurality of runs by counting a number of runs at each node in the plurality of nodes that have the same assigned parameter combination identifier.

### BRIEF DESCRIPTION OF THE DRAWINGS

FIG. 1 illustrates a system topology in accordance with the present disclosure that includes a device, namely a device 200, and a plurality of stages 20 of a process.

FIG. 2 illustrates a device in accordance with an embodiment of the present disclosure.

FIG. 3 illustrates a process hypergraph in accordance with an embodiment of the present disclosure.

FIG. 4 provides further details of a data structure for a plurality of factors and a data structure for a plurality of parameter combinations in accordance with an embodiment of the present disclosure.

FIGS. 5A, 5B, 5C, 5D, 5E and 5G collectively illustrate a flowchart for building a run hypergraph from a plurality of parameter combinations for a process subject to a plurality of run constraints for the process in accordance with an embodiment of the present disclosure.

FIG. 6 illustrates a process hypergraph comprising a plurality of nodes connected by process edges in which a fermenter setup stage is highlighted in accordance with an embodiment of the present disclosure.

FIG. 7 illustrates the process hypergraph of FIG. 6 in which a grow inoculum stage (node) is highlighted in accordance with an embodiment of the present disclosure.

FIG. 8 illustrates the process hypergraph of FIG. 6 in which an inoculate fermenter stage is highlighted in accordance with an embodiment of the present disclosure.

FIG. 9 illustrates the process hypergraph of FIG. 6 in which a fed-batch fermentation stage (node) is highlighted in accordance with an embodiment of the present disclosure.

FIG. 10 illustrates the process hypergraph of FIG. 6 in which a new stage (node) is being added to the process hypergraph of FIG. 6 in accordance with an embodiment of the present disclosure.

FIG. 11 illustrates the process hypergraph of FIG. 10 in which a DW Assay stage (node) and an Off-Gas Assay stage (node) are added to the process hypergraph of FIG. 6 in accordance with an embodiment of the present disclosure.

FIG. 12 illustrates the process hypergraph of FIG. 11 in which a new group of stages (nodes) is added to the process hypergraph of FIG. 6 in accordance with an embodiment of the present disclosure.

FIG. 13 illustrates the process hypergraph of FIG. 12 in which the new group of stages (nodes) is defined in accordance with an embodiment of the present disclosure.

FIG. 14 illustrates how the new group of stages (nodes) defined in the process hypergraph of FIGS. 12 and 13 is defined in accordance with an embodiment of the present disclosure.

FIG. 15 illustrates how the new standards prep stage in the new group of stages (node) defined in the process hypergraph of FIGS. 12 and 13 is defined in accordance with an embodiment of the present disclosure.

FIG. 16 illustrates the initiation of a process for building a run hypergraph from a plurality of parameter combinations for a process subject to a plurality of run constraints for the process in accordance with an embodiment of the present disclosure.

FIG. 17 illustrates identifying a plurality of factors, where each respective factor in the plurality of factors is associated with: (i) an input property in one or more input properties of a resource input in a set of parameterized resource inputs of a corresponding node in a plurality of nodes, or (ii) an output property in the one or more output properties of a resource output in a set of parameterized resource outputs of a corresponding node in a plurality of nodes as well as identifying, for each respective factor in a plurality of factors, a number of levels for the input property or output property associated with the respective factor, in accordance with an embodiment of the present disclosure.

FIG. 18 illustrates defining a plurality of parameter combinations, where each parameter combination in the plurality of parameter combinations is: (i) assigned a unique parameter combination identifier from a plurality of unique parameter combinations identifiers, and (ii) includes an instance of each factor in the plurality of factors, where each respective factor in the instance of the plurality of factors is set to a level in the number of levels of the property associated with the respective factor in accordance with an embodiment of the present disclosure.

FIG. 19 illustrates defining a plurality of run constraints, where each respective run constraint in the plurality of run constraints corresponds to a different parent node/child node pair in a plurality of nodes that are connected by a process edge in a plurality of process edges, and each respective run constraint in the plurality of run constraints specifies a relationship between a number of runs of the parent node to a number of runs for the child node for the corresponding parent node/child node pair, in accordance with an embodiment of the present disclosure.

FIG. 20 illustrates adding each node in a plurality of nodes to a first data structure and adding each parent-child or child-parent node relationship with a first node (in the first data structure) through a process edge in a plurality of process edges to a parent node-child node connection data structure in accordance with an embodiment of the present disclosure.

Like reference numerals refer to corresponding parts throughout the several views of the drawings.

### DETAILED DESCRIPTION

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first subject could be termed a second subject, and, similarly, a second subject could be termed a first subject, without departing from the scope of the present disclosure. The first subject and the second subject are both subjects, but they are not the same subject.

The terminology used in the present disclosure is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

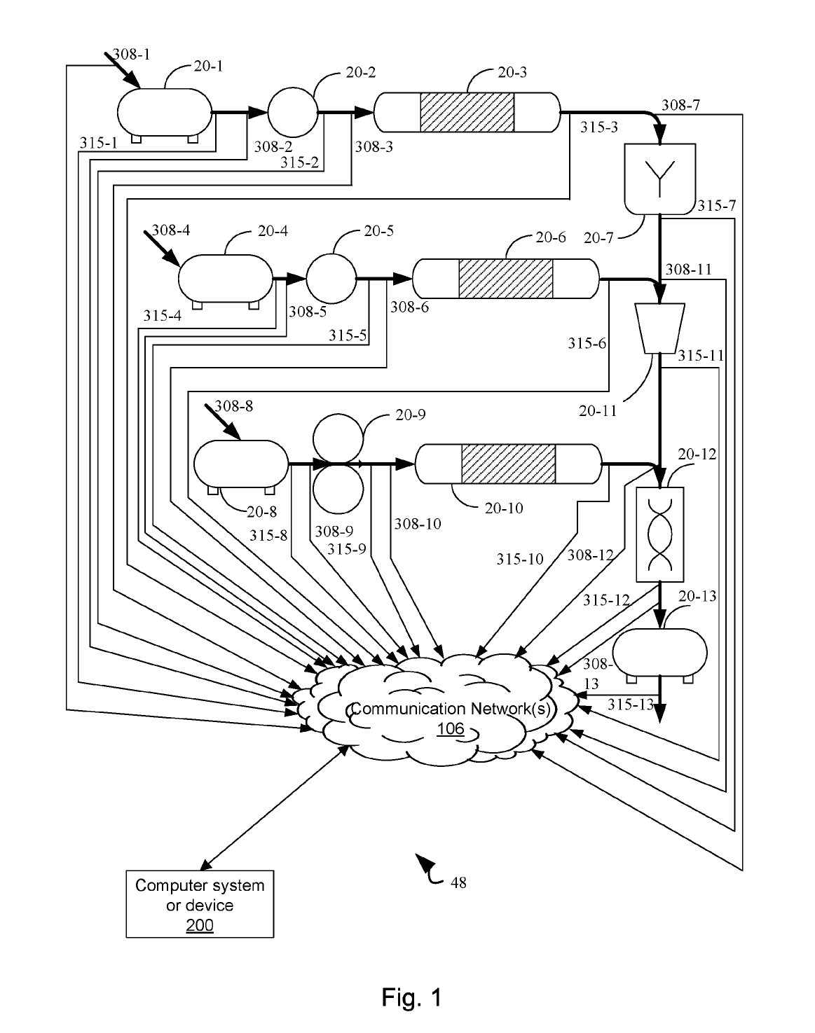

A detailed description of a system 48 for building a run hypergraph from a plurality of parameter combinations for a process subject to a plurality of run constraints for the process in accordance with the present disclosure is described in conjunction with FIGS. 1 through 4. In particular, FIG. 1 illustrates a process or pipeline having a plurality of stages 20. Each respective stage 20 in FIG. 1 is illustrated by an exemplary reaction chamber to indicate that a form of material transformation takes place. However, there is no requirement that this material transformation take place in a reaction chamber. As further schematically illustrated in FIG. 1, each stage 20 includes a set of parameterized inputs 308 and a set of parameterized outputs 315. In some embodiments, as illustrated in FIG. 1, a description of these inputs 308 and outputs 315 is provided to computer system 200, or more generically a device 200, possibly over communications network 106. For instance, at stage 20-2, when a process completes this stage, a file that includes the parameterized outputs of this stage is stored in a directory associated with this stage. Then, a sweeping or monitoring process takes this new file and sends it to computer system 200 where it is uploaded into a corresponding process run stored in the computer system 200. In more detail, in some embodiments, inputs 308 or outputs 315 are electronically measured by measuring devices. For instance, in some embodiments a software component such as a sync engine that runs as a background process (like Google Drive or Dropbox Sync) on any computer attached to an instrument or other component of a stage 20 monitors a synced folder. When new instrument data files are added to the folder, the software parses and sends the data associated with the stage across the communications network 106 to the computer system 200. In some embodiments, a hardware solution is used to communicate the set of inputs 308 and outputs 315 of the stages 20 of a process. In such an approach, data acquisition and transfer is performed by direct interface with instruments or other components of stages 20. For instance, in some embodiments a BeagleBone black microcontroller (http://beagleboard.org/BLACK) is used to transmit such data to the computer system 200 across the network 106. In some embodiments, data (e.g., values for a set of parameterized resource inputs 310 and/or values for a set of parameterized resource outputs 315 associated with a stage 20 of a process) is communicated from the respective stages 20 to the computer system via HTTPS port 443 via HTTP POSTs or representational state transfer.

Of course, other topologies of system 48 are possible, for instance, computer system 200 can in fact constitute several computers that are linked together in a network or be a virtual machine in a cloud computing context. As such, the exemplary topology shown in FIG. 1 merely serves to describe the features of an embodiment of the present disclosure in a manner that will be readily understood to one of skill in the art.

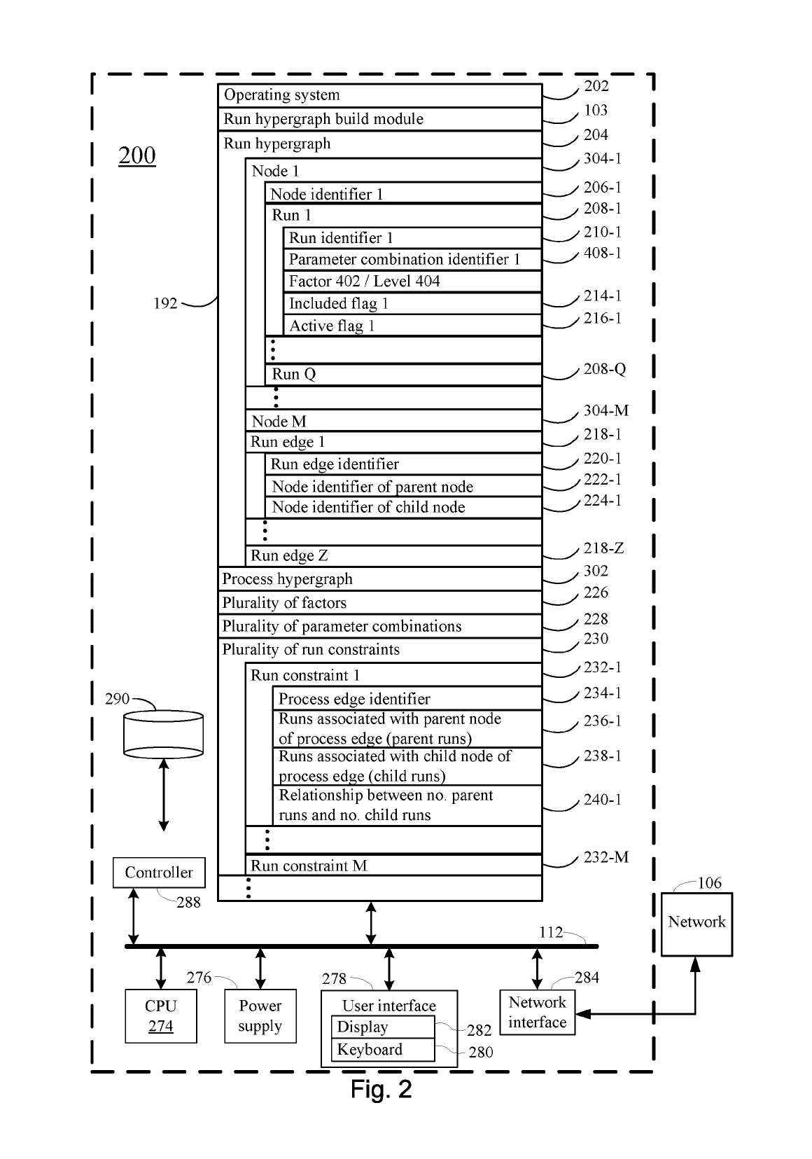

Referring to FIG. 2, in typical embodiments, a computer system 200 for building a run hypergraph 204 from a plurality of parameter combinations 228 for a process subject to a plurality of run constraints 230 for the process comprises one or more computers. For purposes of illustration in FIG. 2, the computer system 200 is represented as a single computer that includes all of the functionality of the computer system 200. However, the disclosure is not so limited. The functionality of the computer system 200 may be spread across any number of networked computers and/or reside on each of several networked computers or other devices and/or by hosted on one or more virtual machines or other devices at one or more remote locations accessible across the communications network 106. One of skill in the art will appreciate that a wide array of different computer and/or device topologies are possible for the computer system 200 and all such topologies are within the scope of the present disclosure.

Turning to FIG. 2, a computer system 200 in accordance with one aspect of the present disclosure comprises one or more processing units (CPU's) 274, a network or other communications interface 284, a memory 192 (e.g., random access memory), one or more magnetic disk storage and/or persistent devices 290 optionally accessed by one or more controllers 288, one or more communication busses 112 for interconnecting the aforementioned components, and a power supply 276 for powering the aforementioned components. Data in memory 192 can be seamlessly shared with non-volatile memory 290 using known computing techniques such as caching. Memory 192 and/or memory 290 can include mass storage that is remotely located with respect to the central processing unit(s) 274. In other words, some data stored in memory 192 and/or memory 290 may in fact be hosted on computers that are external to computer system 200 but that can be electronically accessed by the computer system over an Internet, intranet, or other form of network or electronic cable (illustrated as element 106 in FIG. 2) using network interface 284. In some embodiments computer system 200 further includes a user interface 278 comprising a display 282 and a user keyboard 280.

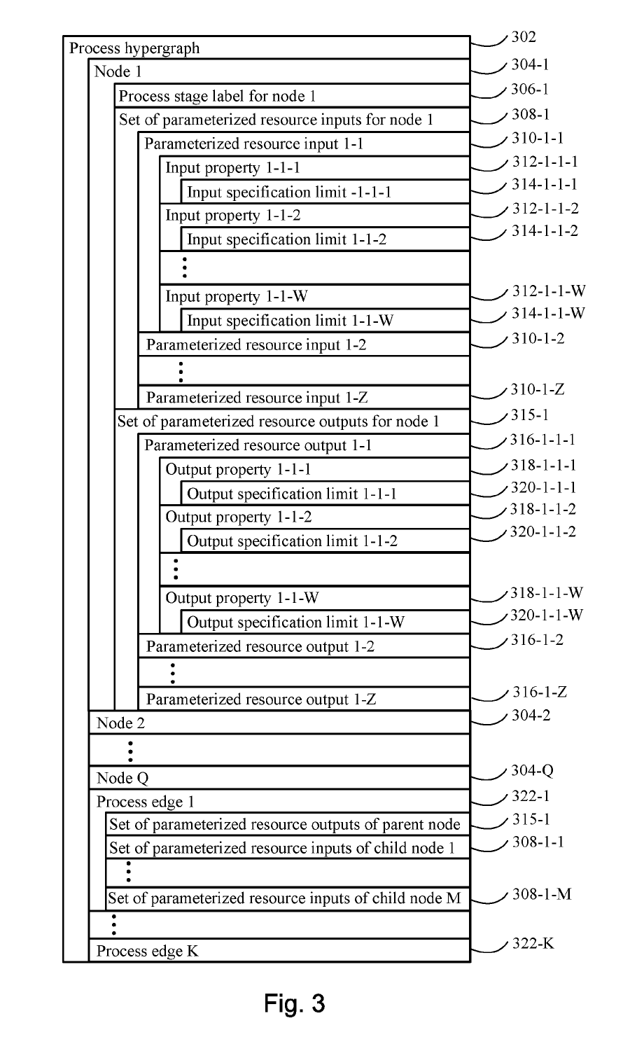

The memory 192 of computer system 200 stores:
an operating system 202 that includes procedures for handling various basic system services;
A run hypergraph build module 103 for building a run hypergraph 204 from a plurality of parameter combinations 228 for a process subject to a plurality of run constraints 230 for the process;
a run hypergraph 204, the run hypergraph comprising (i) a plurality of nodes 304, (ii) a plurality of runs, each run 208 in the plurality of runs being associated with a node 304 in the plurality of nodes, and (iii) a plurality of run edges 218.
a process hypergraph 302, the process hypergraph comprising (i) the plurality of nodes of the run hypergraph 304 and (ii) a plurality of process edges, where each process edge joins a parent node to a daughter node in the plurality of nodes;
a plurality of factors 226;
a plurality of parameter combinations 228, where each respective parameter combination in the plurality of parameter combinations 228 comprises an instance of the plurality of factors (alternatively phrased as an instance of each factor in the plurality of factors); and
a plurality of run constraints 230, where each respective run constraint 232 in the plurality of run constraints 230 corresponds to a different parent node 304/child node 304 pair in the plurality of nodes that are connected by a process edge 322 (described in FIG. 3) in a plurality of process edges, and each respective run constraint 232 in the plurality of run constraints specifies a relationship between a number of runs of the parent node to a number of runs for the child node for the corresponding parent node/child node pair.

In some implementations, one or more of the above identified data elements or modules of the computer system 200 are stored in one or more of the previously mentioned memory devices, and correspond to a set of instructions for performing a function described above. The above identified data, modules or programs (e.g., sets of instructions) need not be implemented as separate software programs, procedures or modules, and thus various subsets of these modules may be combined or otherwise re-arranged in various implementations. In some implementations, the memory 192 and/or 290 optionally stores a subset of the modules and data structures identified above. Furthermore, in some embodiments the memory 192 and/or 290 stores additional modules and data structures not described above.

Turning to FIG. 3, more details of a process hypergraph 302 are described. The process hypergraph 302 comprises a plurality of nodes, is directional, causal, and sequential based. For instance, each respective node 304 in the plurality of nodes is connected to at least one other node in the plurality of nodes by a process edge 322. Each respective node 304 in the plurality of nodes comprises a process stage label 306 representing a respective stage (node) in the corresponding process.

In some embodiments, a node 304 is a complete and self-contained description of a transformative event that can be used to build larger processes. A node 304 is sufficiently general to serve in a wide array of processes, such as chemical processes, life science processes, and food preparation processes. Advantageously, nodes 304 do not lose their meaning or utility when copied into other processes. As such, the definition of a node 304 does not depend on the definition of other nodes in a process hypergraph 302 in preferred embodiments.

Each respective node 304 in the plurality of nodes of a process hypergraph 304 is associated with a set of parameterized resource inputs 308 to the respective stage in the corresponding process. At least one parameterized resource input 310 in the set of parameterized resource inputs 308 is associated with one or more input properties 312, the one or more input properties including an input specification limit 314. Examples of input properties 312 are the attributes (e.g., measurements, quantities, etc.) of things such as people, equipment, materials, and data. There can be multiple input properties for a single parameterized resource input (e.g., temperature, flow rate, viscosity, pH, purity, etc.). In some embodiments, there is a single input property for a particular parameterized resource input.

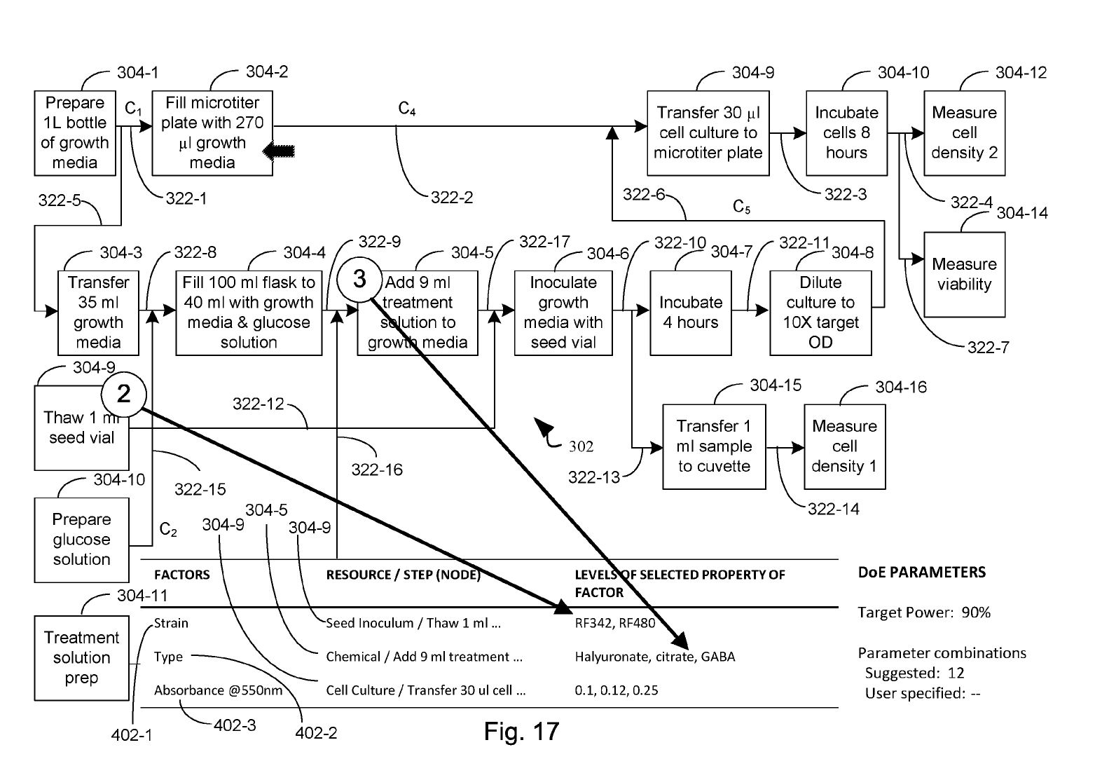

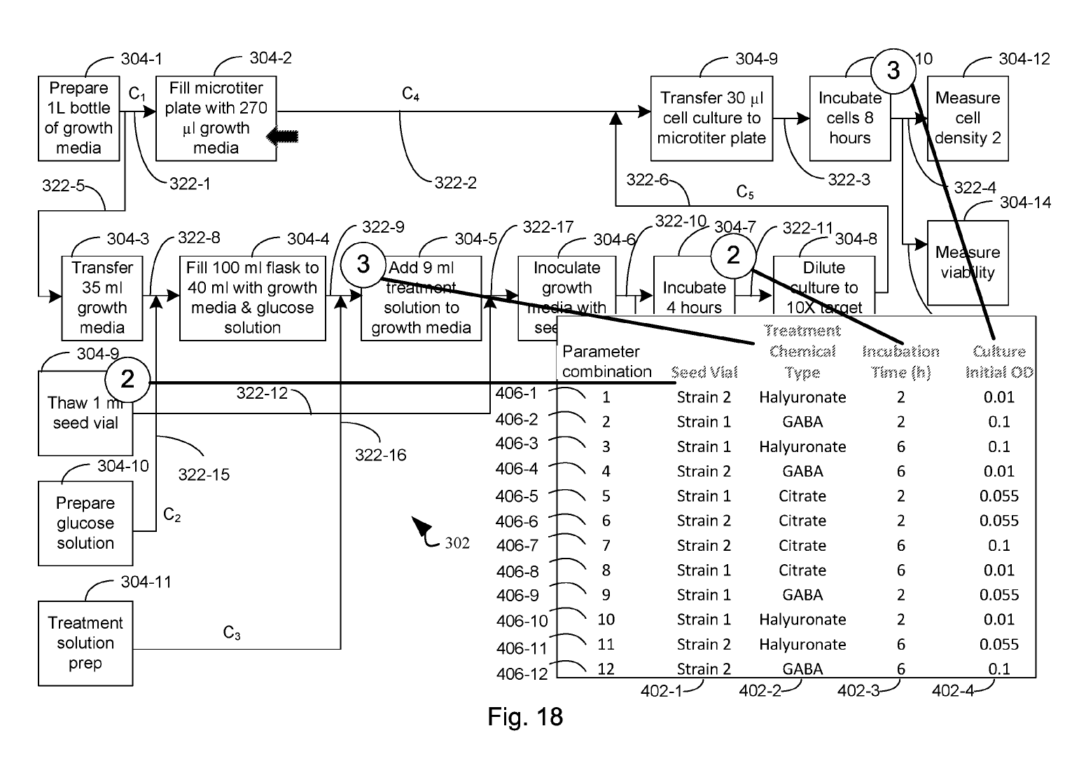

Each respective node 304 in the plurality of nodes is also associated with a set of parameterized resource outputs 315 to the respective stage in the corresponding process. At least one parameterized resource output 316 in the set of parameterized resource outputs 315 is associated with one or more output properties 318, the one or more output properties including a corresponding output specification limit 320. Examples of output properties 318 include attributes (e.g., measurements, quantities, etc.) of things such as people, equipment, materials, and data. There can be multiple output properties for a single parameterized resource output. In some embodiments, there is a single output property for a particular parameterized resource output. Further discussion of such parameterized resource inputs and parameterized resource outputs is disclosed in PCT publication WO 2016/019188 A1 entitled “Systems and Methods for Process Design and Analysis,” in particular the text describing FIGS. 17 and 18 of WO 2016/019188 A1, which is hereby incorporated by reference.

Returning to FIG. 3, each process hypergraph 302 includes a plurality of process edges. Each respective process edge 322 in the plurality of process edges specifies that the set of parameterized resource outputs 315 of a source node 304 in the plurality of nodes is included in the set of parameterized resource inputs 308 of at least one other destination node 304 in the plurality of nodes. In other words, a process edge specifies that the state of a material, equipment, people or other thing inputted into one node (destination node) in a given process is identical to the state of material, equipment, people, or other thing that has been outputted from another node (source node) in the hypergraph for that process. In some embodiments, a process edge 322 specifies that the state of a material, equipment, people or other thing inputted into a plurality of nodes (destination node) is identical in a given process to the state of material, equipment, people, or other thing that has been outputted from another node (source node) in the hypergraph for that process. Moreover, a destination node may be connected to two or more source nodes meaning that the input of the destination node includes material, equipment, people or other thing in the same state as it was in the output of the two or more source nodes for a given process.

As FIG. 3 illustrates, each node 304 in the process hypergraph 302 has inputs (set of parameterized resource inputs 308), and each of these parameterized resource inputs 310 has one or more input properties 312, and each these input properties has input specification limits 314. Further, each node 304 has one or more parameterized resource outputs (set of parameterized resource outputs 315), and each of these parameterized resource outputs 316 has one or more output properties 318. Moreover, each of these output properties has an output specification limit 320. The set of parameterized resource outputs 315 serves as the inputs to other nodes and such relationships are denoted by process edges 322. Moreover, the set of parameterized resource outputs 315 of a particular node can serve as the inputs to more than one node, thus the process edges 322 and nodes 304 constitute a process hypergraph 302. By defining a process in this way, it is possible to integrate data acquisition from disparate sources and devices, and query process runs to identify correlations, reduce experimental variance, and improve process reproducibility as disclosed in PCT publication WO 2016/019188 A1 entitled “Systems and Methods for Process Design and Analysis,” in particular the text describing FIGS. 17 and 18 of WO 2016/019188 A1, which is hereby incorporated by reference.

In some instances, a destination node 304 of a process hypergraph 302 includes only a single process edge 322 from one source node 324. In such instances, the set of parameterized resource outputs 315 for the source node 324 constitutes the entire set of parameterized resource inputs 308 for the destination node 326.

To illustrate the concept of a node in a process represented by a process hypergraph 302, consider a node that is designed to measure the temperature of fermenter broth. The set of parameterized inputs 308 to this node include a description of the fermenter broth and the thermocouple that makes the temperature measurement. The thermocouple will include input properties that include its cleanliness state, calibration state and other properties of the thermocouple. The set of parameterized outputs 315 to this node 304 include the temperature of the fermenter broth, and output specification limits for this temperature (e.g., an acceptable range for the temperature). Another possible parameterized resource output 316 of the node 304 is the thermocouple itself along with properties 318 of the thermocouple after the temperature has been taken, such as its cleanliness state and calibration state. For each of these output properties 318 there is again a corresponding output specification limit 320.

In some instances, a destination node of a process hypergraph 302 includes multiple process edges 322, each such edge from a different source node. In such instances, the set of parameterized resource outputs 315 for each such source node collectively constitute the set of parameterized resource inputs 308 for the destination node.

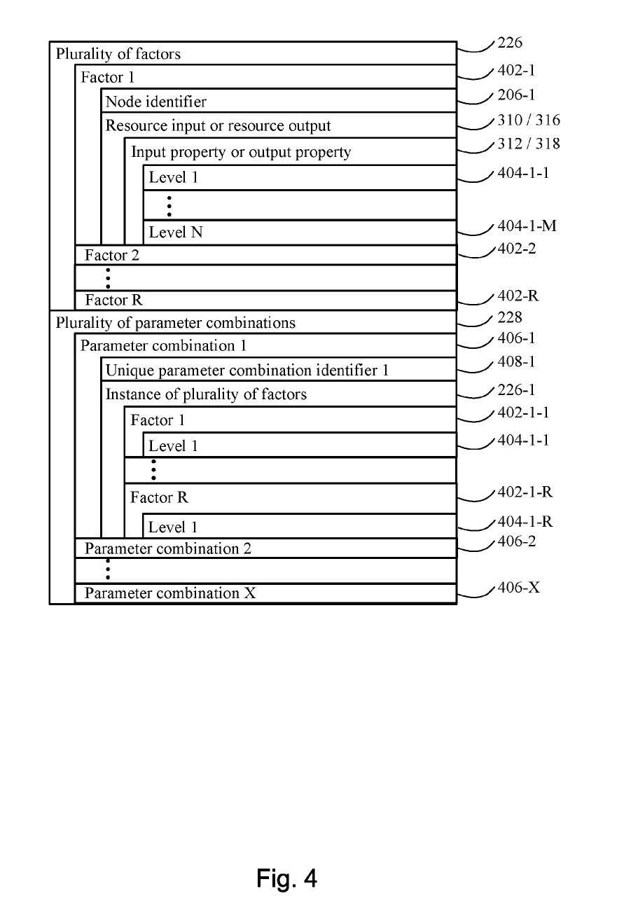

FIG. 4 provides an example data structure for a plurality of factors 226. As illustrated in FIG. 4, each respective factor 402 in the plurality of factors is associated with a node identifier 206 of a node 304 and either (i) an input property 312 in the one or more input properties of a resource input 310 in the set of parameterized resource inputs 308 of the node 304 in the plurality of nodes identified by the node identifier 206, or (ii) an output property 318 in the one or more output properties of a resource output 316 in the set of parameterized resource outputs 315 of the node 304 in the plurality of nodes identified by the node identifier 206. Further, for each respective factor 402 in the plurality of factors, there is a number of levels 404 for the input property 312 or output property 318 associated with the respective factor 402. For instance, consider the case where an input property 312 is designated for a particular factor 402 and this input property is a purity value. In this instance, examples of levels 404 for the purity value, and thus the respective factor 402, would be 90 percent pure, 95 percent pure, 99 percent pure, and so forth. As another example, consider the case where an output property 318 is designated for a particular factor 402 and this output property is a temperature value. In this instance, examples of levels 404 for the temperature value, and thus the respective factor 402, would be 45 degrees Celsius, 46 degrees Celsius, 47 degrees Celsius, and so forth.

FIG. 4 also provides an example data structure for a plurality of parameter combinations 228. As illustrated in FIG. 4, each respective parameter combination 406 in the plurality of parameter combinations 228 includes (i) a unique parameter combination identifier 408 from a plurality of unique parameter combinations identifiers, and (ii) an instance of each factor 402 in the plurality of factors 226, where each respective factor in the instance of the plurality of factors is set to a level 404 in the number of levels of the input property 312 or output property 318 associated with the respective factor.

As an example, consider the case where a plurality of factors 226 consists of 10 factors, with each of the 10 factors having one of two possible levels. A first parameter combination 406-1 in the plurality of parameter combinations 228 will contain a first instance of the plurality of factors 226-1 (10 factors), with each respective factor 402 in the first instance of the plurality of factors 226-1 independently assigned to one of the two possible levels 404 for the respective factor, a second parameter combination 406-2 in the plurality of parameter combinations 228 will contain a second instance of the plurality of factors 226-2 (10 factors), with each respective factor 402 in the second instance of the plurality of factors 226-1 independently assigned to one of the two possible levels 404 for the respective factor, and so forth.

As another example, consider the case where a plurality of factors 226 consists of 5 factors, with each of the 5 factors having one of a plurality of possible levels. A first parameter combination 406-1 in the plurality of parameter combinations 228 will contain a first instance of the plurality of factors 226-1 (5 factors), with each respective factor 402 in the first instance of the plurality of factors 226-1 independently assigned to one of the plurality of possible levels 404 for the respective factor, a second parameter combination 406-2 in the plurality of parameter combinations 228 will contain a second instance of the plurality of factors 226-2 (5 factors), with each respective factor 402 in the second instance of the plurality of factors 226-1 independently assigned to one of the plurality of possible levels 404 for the respective factor, and so forth.

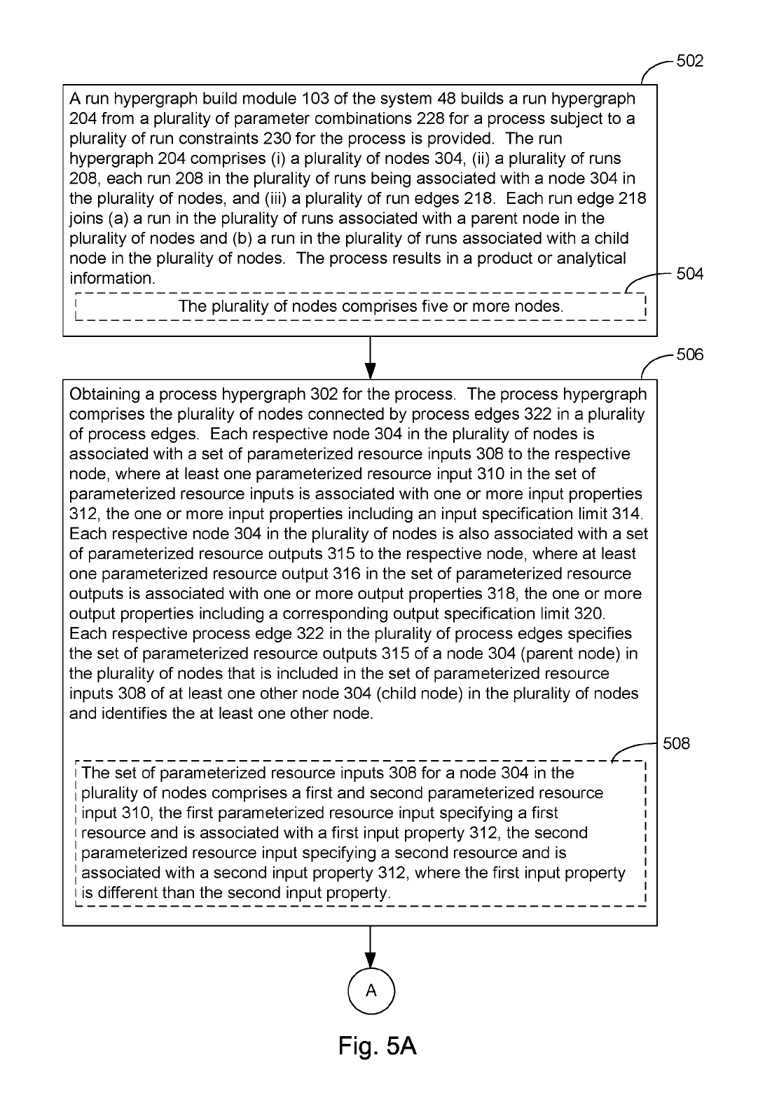

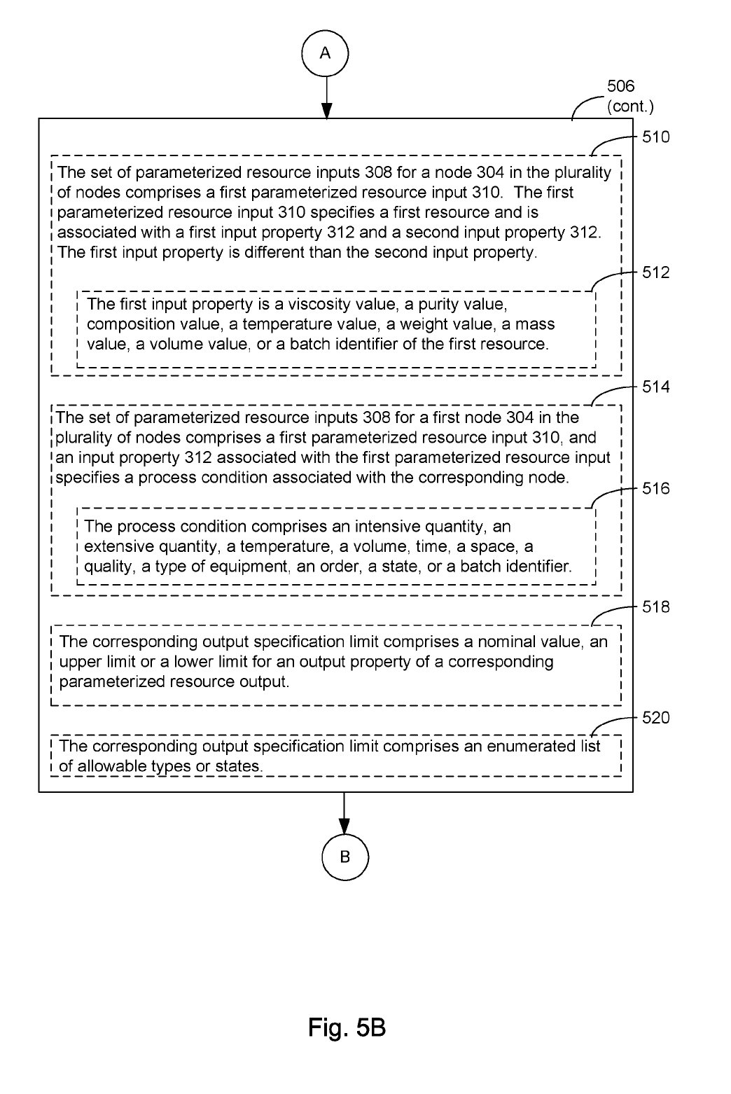

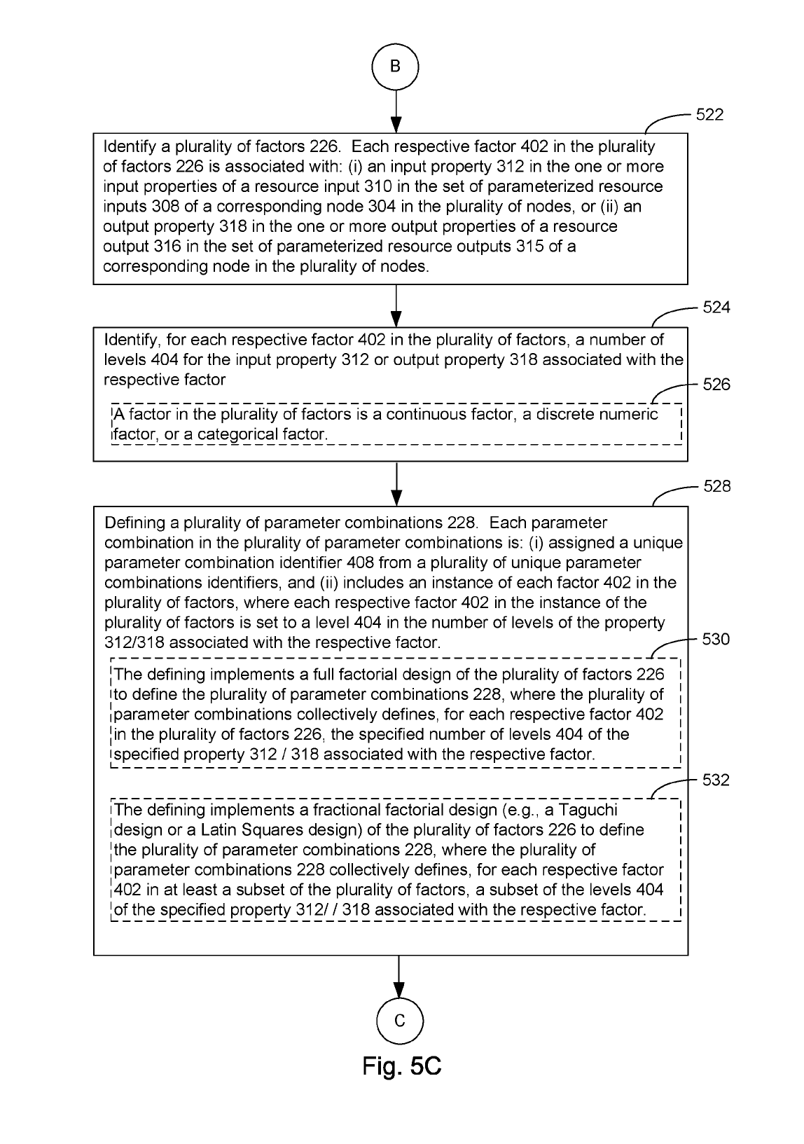

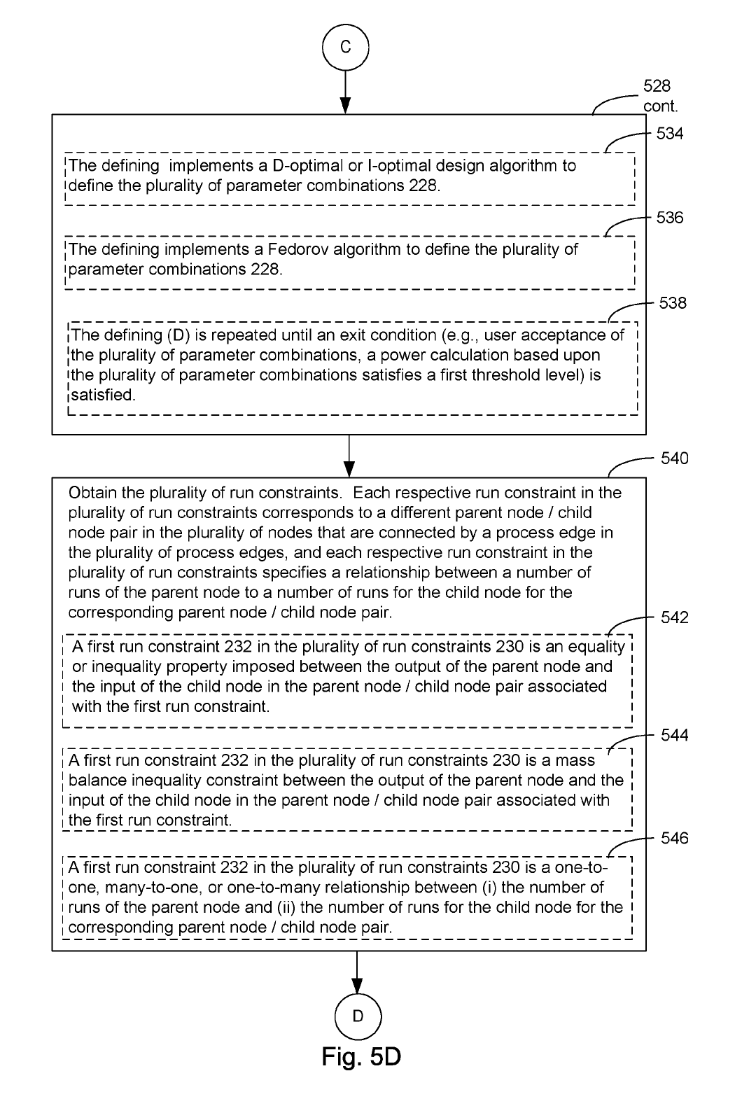

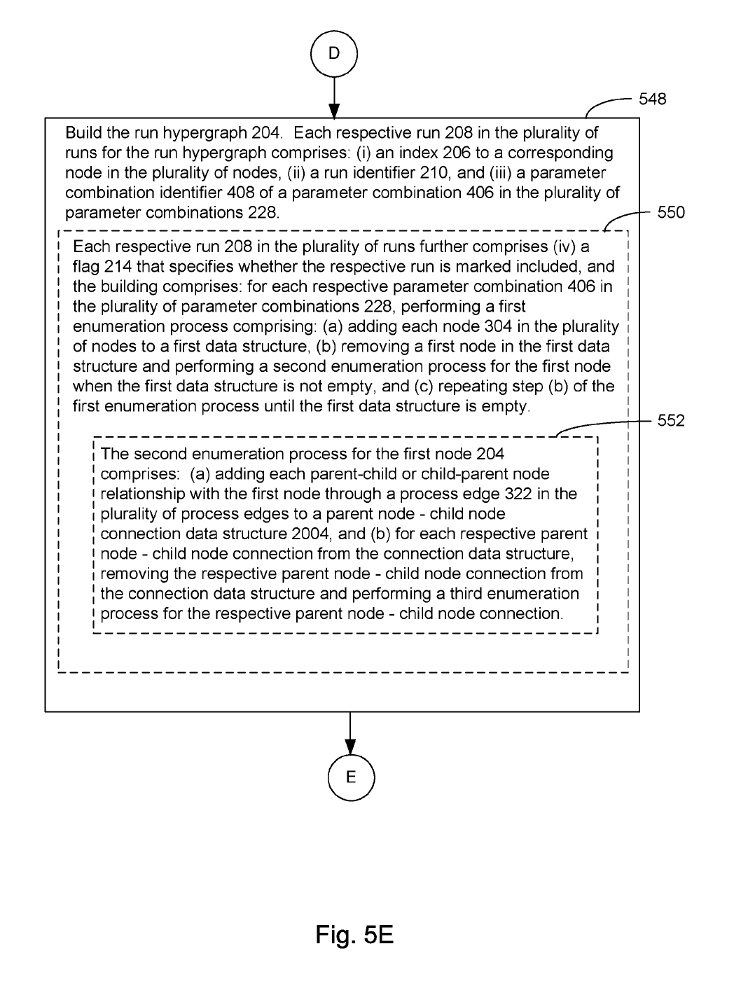

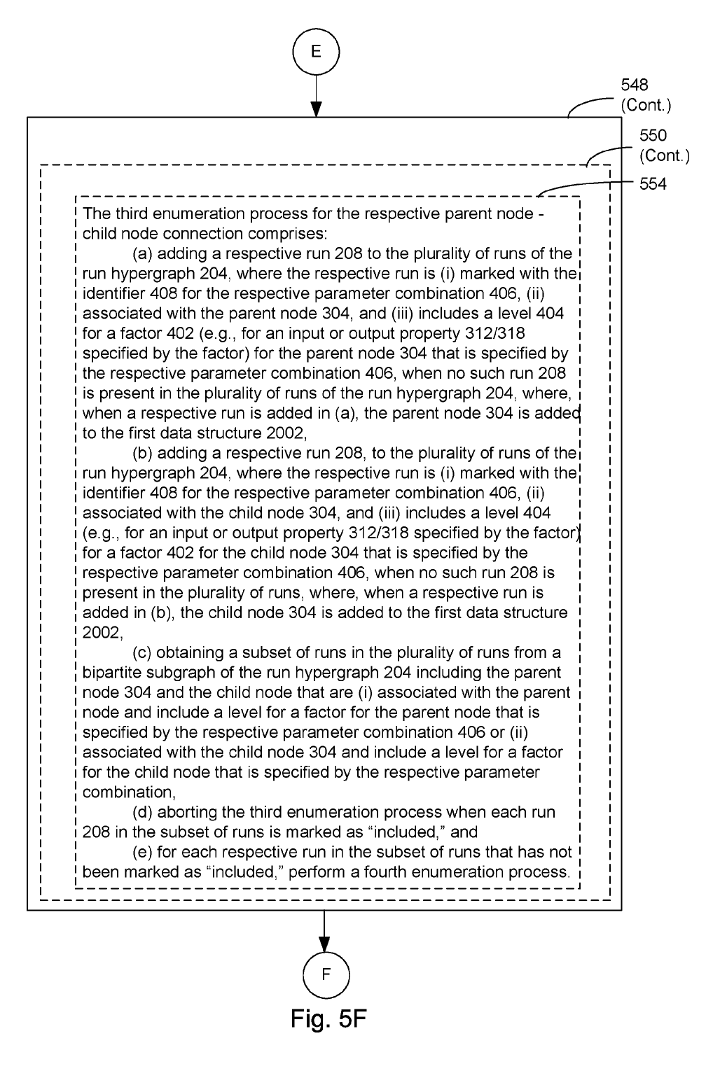

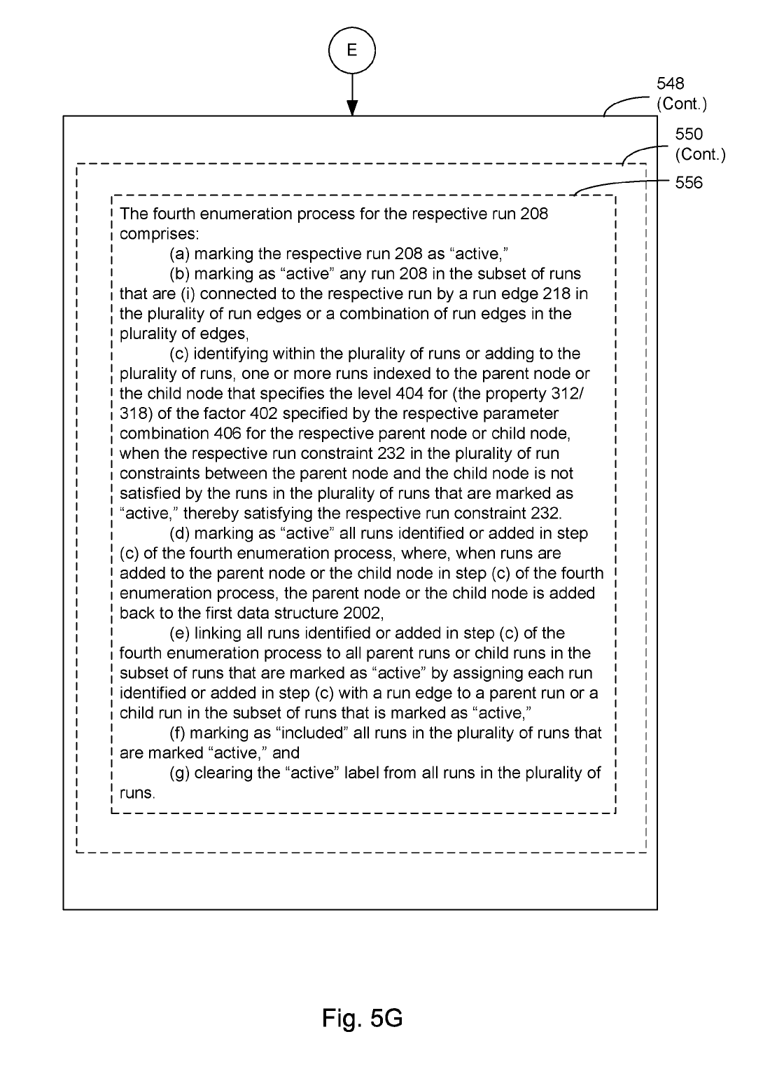

Now that details of a system 48 for building a run hypergraph 204 from a plurality of parameter combinations 228 for a process subject to a plurality of run constraints 230 for the process have been disclosed, details regarding how a run hypergraph build module 103 of the system 48 builds a run hypergraph 204 in accordance with an embodiment of the present disclosure are disclosed with reference to FIG. 5.

Referring to block 502, A run hypergraph build module 103 of the system 48 builds a run hypergraph 204 from a plurality of parameter combinations 228 for a process subject to a plurality of run constraints 230 for the process is provided. The run hypergraph 204 comprises (i) a plurality of nodes 304, (ii) a plurality of runs 208, each run 208 in the plurality of runs being associated with a node 304 in the plurality of nodes, and (iii) a plurality of run edges 218. Each run edge 218 joins (a) a run in the plurality of runs associated with a parent node in the plurality of nodes and (b) a run in the plurality of runs associated with a child node in the plurality of nodes. The process results in a product or analytical information. The non-transitory computer readable storage medium stores instructions, which when executed by a first device, cause the first device to perform a method.

Referring to block 504, in some embodiments, the plurality of nodes comprises five or more nodes, 10 or more nodes, 15 or more nodes, or 100, or more nodes.

Referring to block 506, a process hypergraph 302 is obtained for the process. The process hypergraph 302 comprise a plurality of nodes 304 connected by process edges 322 in a plurality of process edges. Each respective node 304 in the plurality of nodes comprises a process stage label representing a respective stage in the corresponding process.

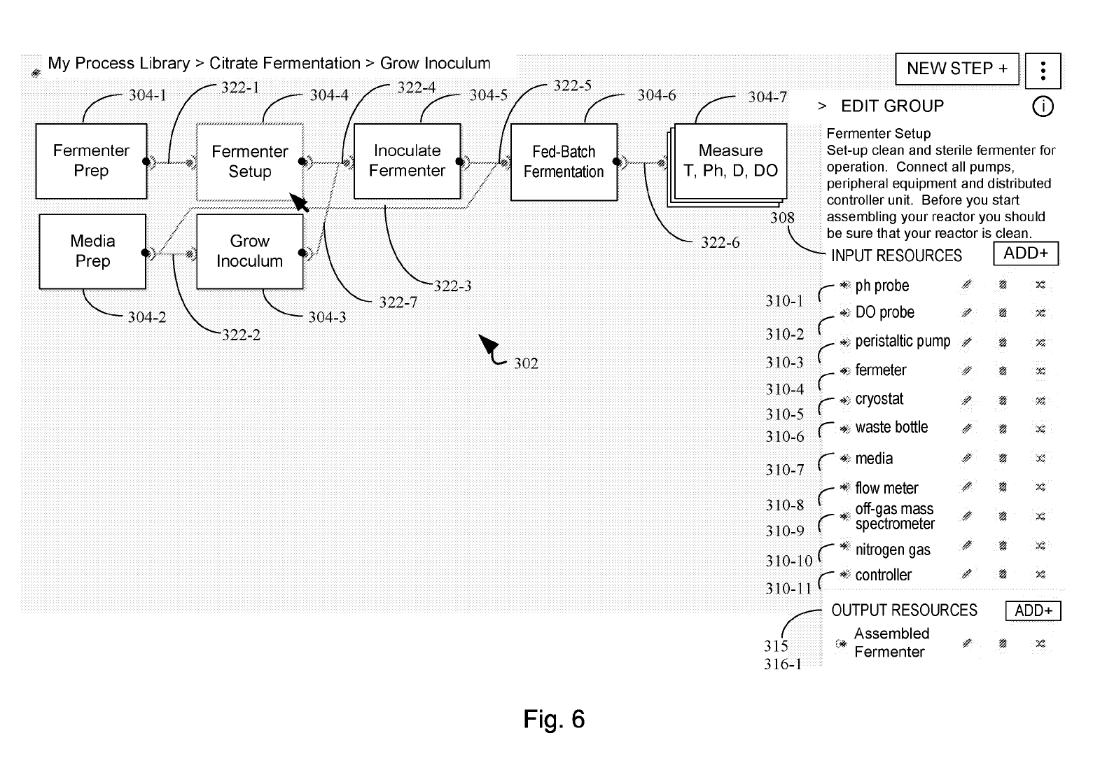

FIG. 6 illustrates a process hypergraph 302 that includes a plurality of nodes 304 corresponding to respective stages of a process (e.g., “Fermenter Prep,” “Fermenter Setup,” “Media Prep,” “Grow Inoculum,” “Innoculate Fermenter,” “Fed-Batch Fermentation,” and “Measure T, Ph, D, DO”). In some embodiments, concurrency is supported. That is, multiple users, each operating at a different client computer in communication with computer system 200, can view an instance of the process version displayed in FIG. 6, make changes to it, and view and analyze data from process runs that make use of it.

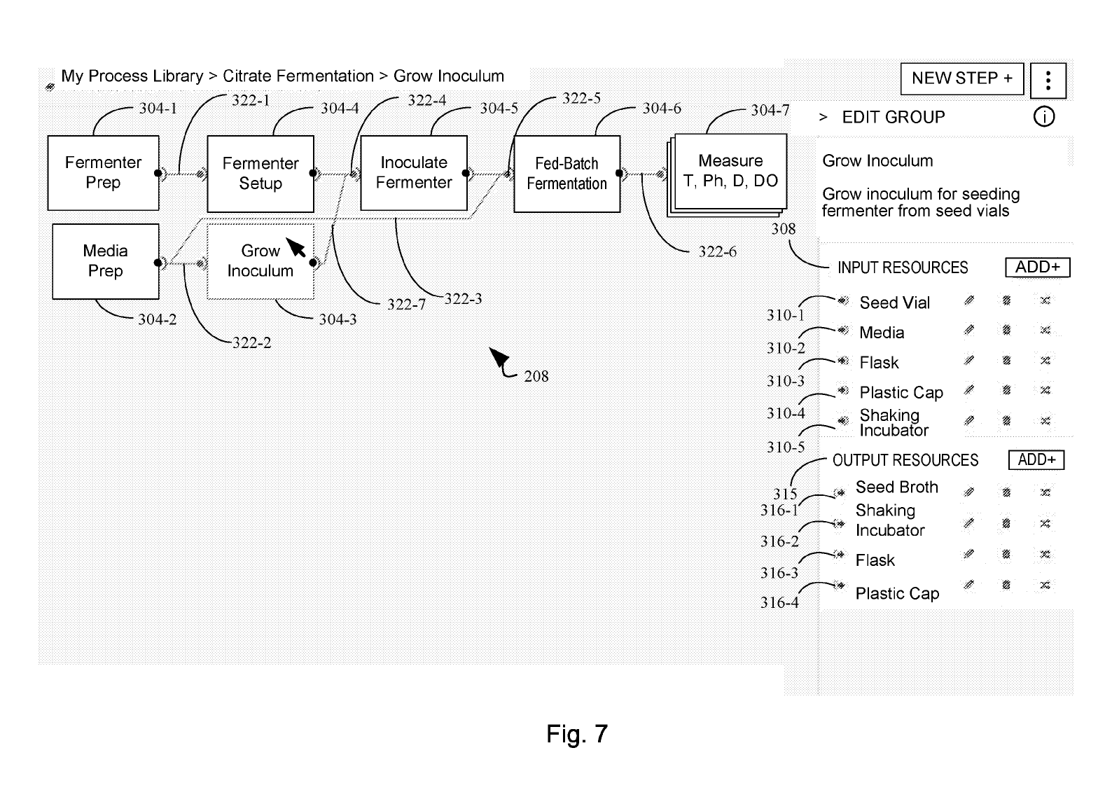

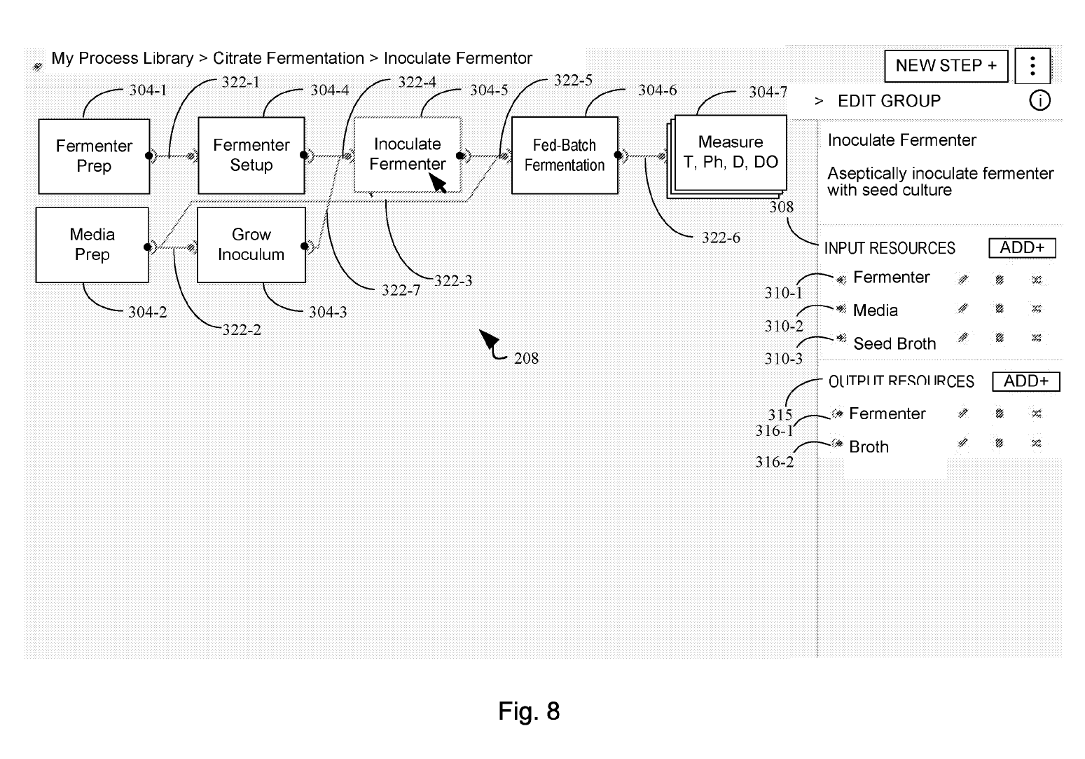

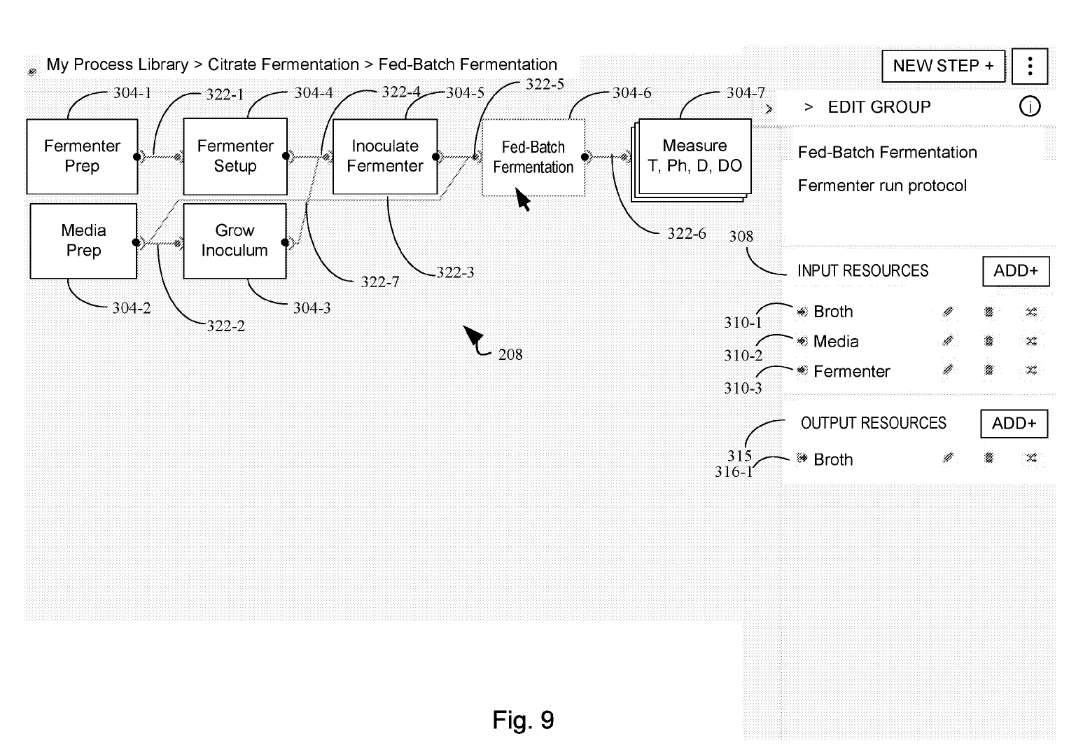

Each node 304 is associated with a set of parameterized resource inputs 308 to the respective stage in the corresponding process. At least one parameterized resource input 310 in the set of parameterized resource inputs 308 is associated with one or more input properties 312. The one or more input properties include an input specification limit 314. Each node 304 is also associated with a set of parameterized resource outputs 315 to the respective stage in the corresponding process. At least one parameterized resource output 316 in the set of parameterized resource outputs is associated with one or more output properties. The one or more output properties include a corresponding output specification limit. FIG. 6 illustrates the set of parameterized resource inputs 308 and the set of parameterized resource outputs 315 for the node 304-4 “Fermenter Setup.” FIG. 7 illustrates the set of parameterized resource inputs 308 and the set of parameterized resource outputs 315 for the node 304-3 “Grow Inoculum.” FIG. 8 illustrates the set of parameterized resource inputs 308 and the set of parameterized resource outputs 315 for the node 304-5 “Inoculate Fermenter.” FIG. 9 illustrates the set of parameterized resource inputs 308 and the set of parameterized resource outputs 315 for the node 304-6 “Fed-Batch Fermentation.” In some embodiments, a user can simply click on a node 304 to see their inputs and outputs. Moreover, unstructured data in the form of videos, pictures, or comments can be added to nodes 304. For example, a video showing the proper way to perform a procedure associated with a node can be linked to a node by simply dragging an icon link to the video onto the representation of node 304. For example, a video on the proper way perform a fermenter setup can be dragged onto the “Fermenter Setup” node 304-4 of FIG. 6. Thereafter, when a user clicks on node 304-4, the video is played.

Each respective process edge 322 in the plurality of process edges specifies that the set of parameterized resource outputs of a node in the plurality of nodes is included in the set of parameterized resource inputs of at least one other node in the plurality of nodes. Thus, turning to FIG. 6 to illustrate, the set of parameterized resource inputs for node 304-6 “Fed-Batch Fermentation” consists of the set of parameterized resource outputs for nodes 304-5 “Inoculate Fermenter” and 304-2 “Media Prep.”

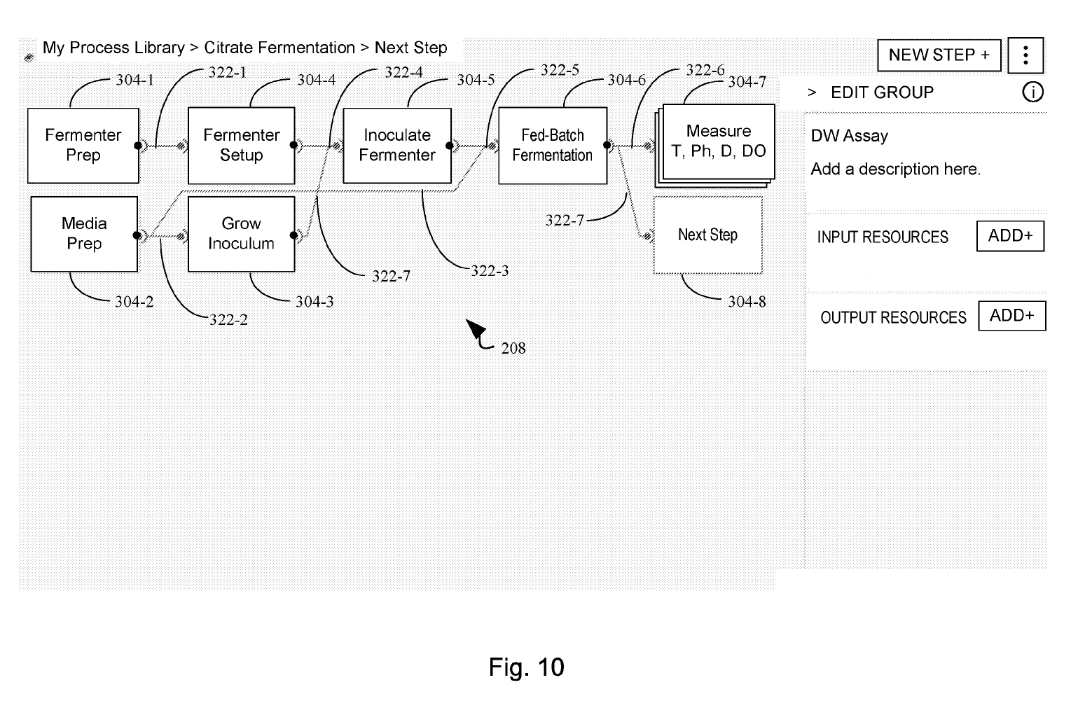

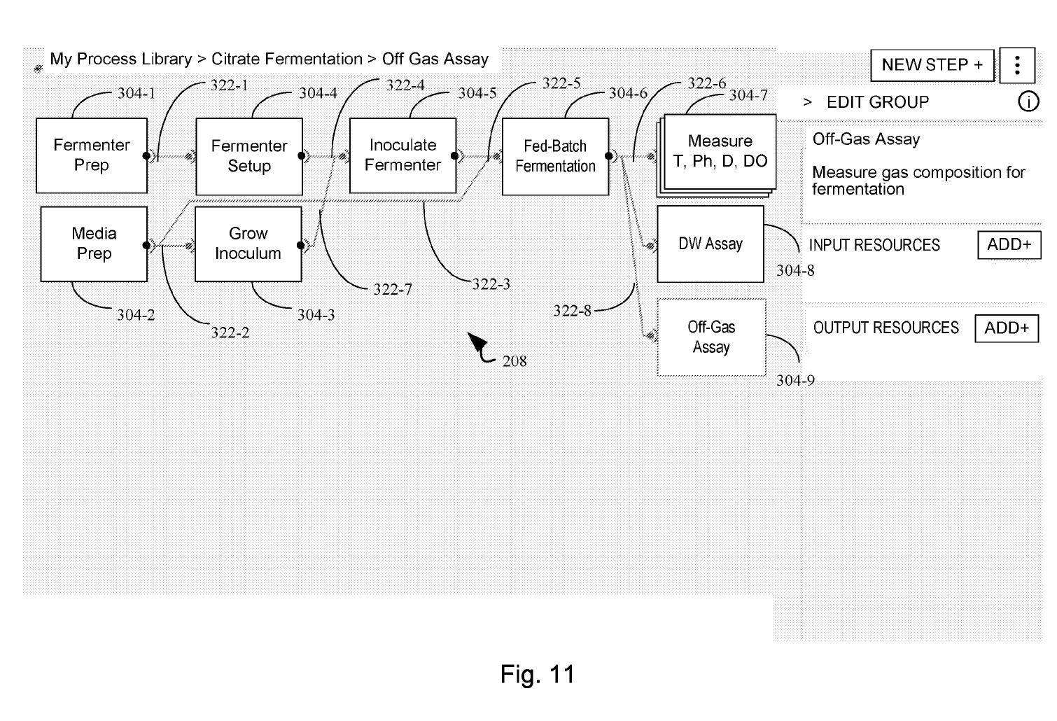

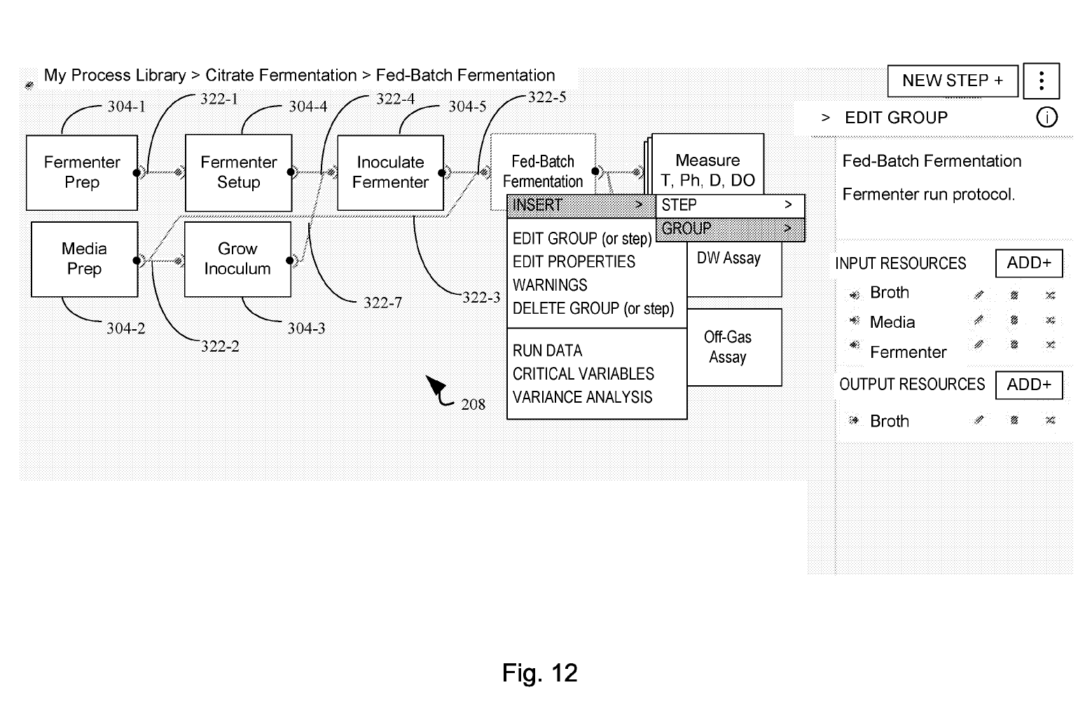

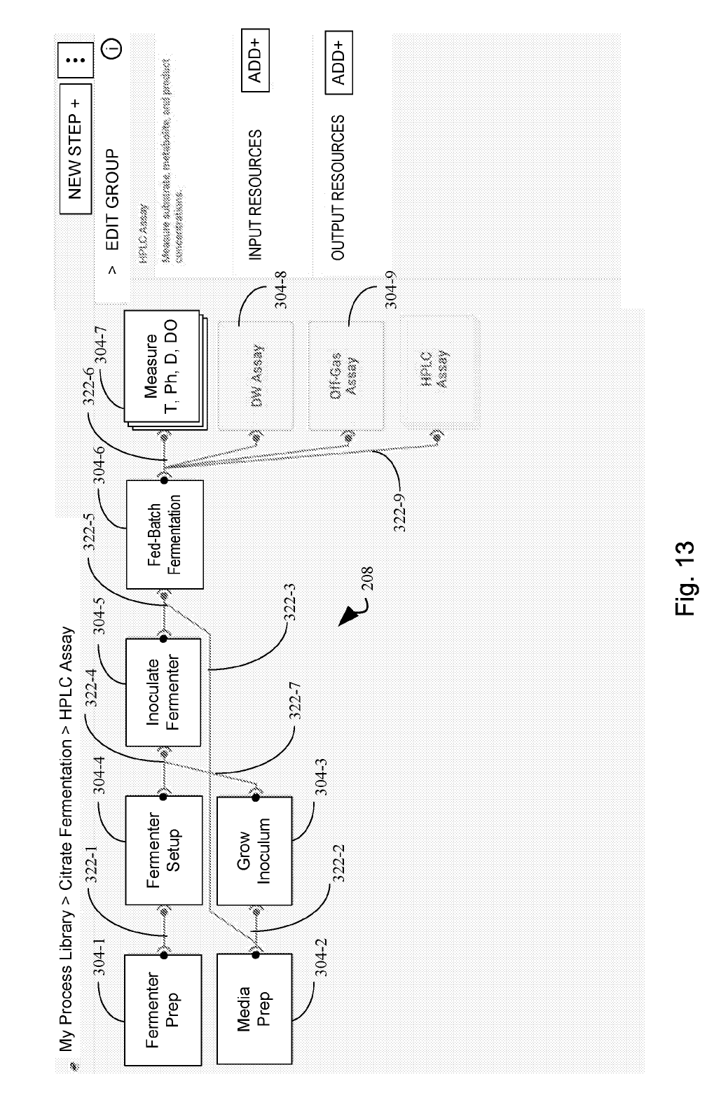

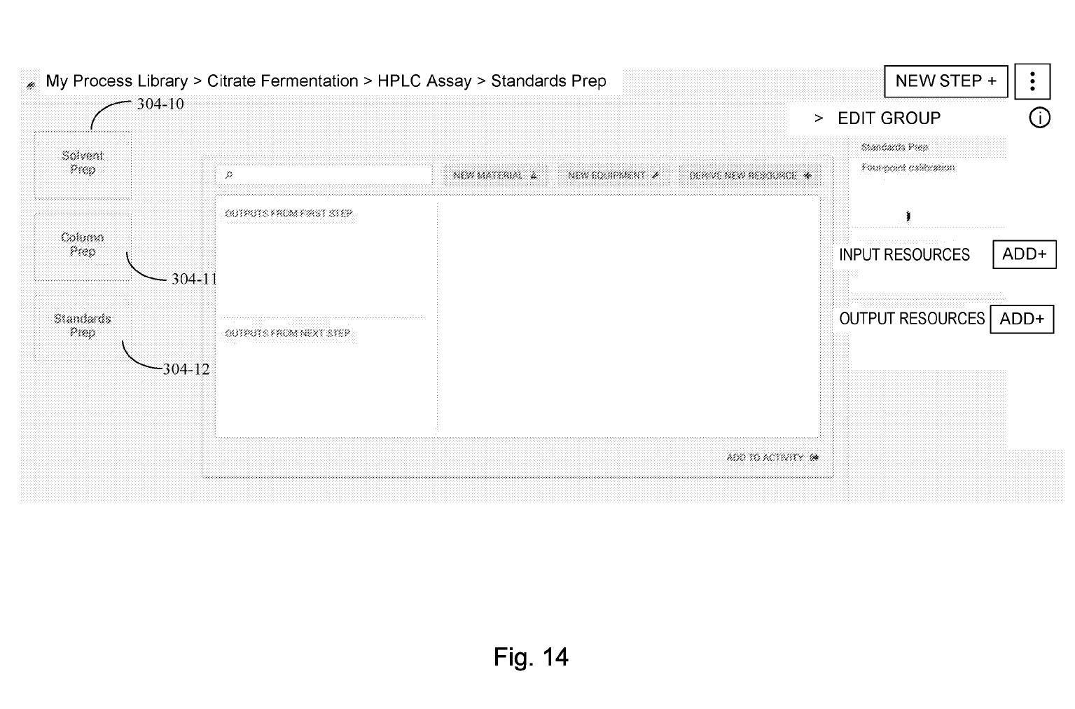

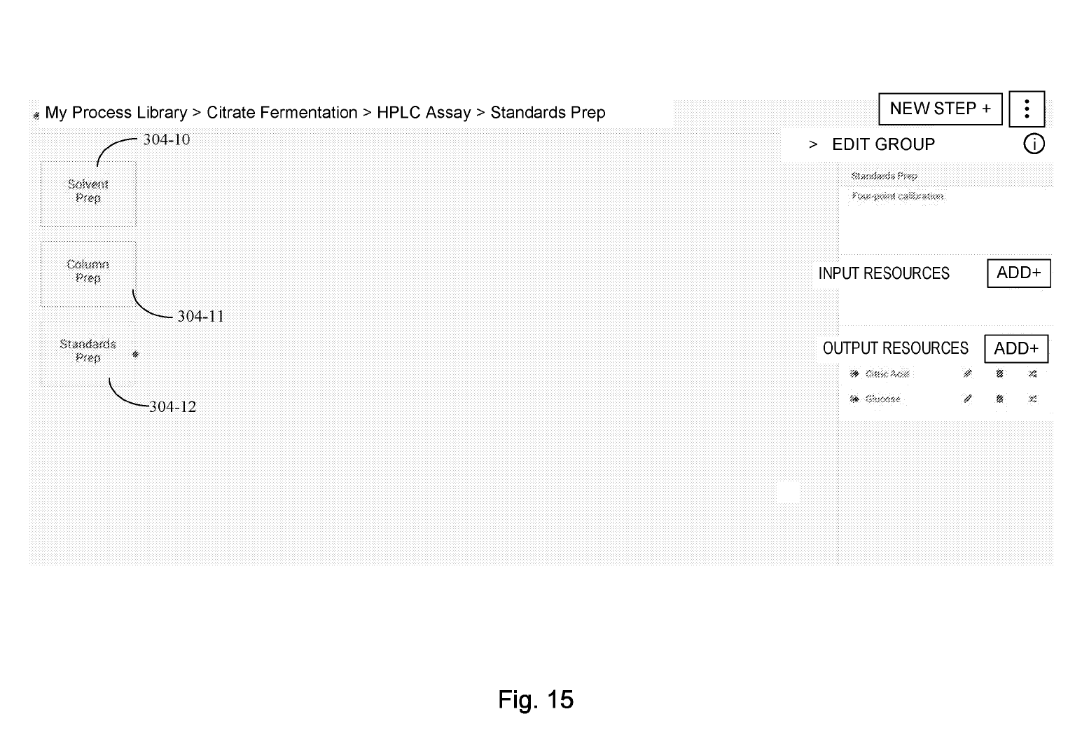

FIGS. 10 and 11 illustrate adding new nodes 304-8 “DW Assay” and 304-9 “Off-Gas Assay” to an existing hypergraph and FIGS. 12 and 13 illustrate adding a group of nodes entitled “HPLC Assay” to the hypergraph. The HPLC Assay group is an extension of the existing hypergraph of FIG. 6 and includes nodes and process edges of this extension. Referring to FIGS. 13 and 14, HPLC Assay begins with three initial nodes, node 304-10 “Solvent Prep,” node 304-11 “Column Prep,” and node 304-12 “Standards Prep.” In some embodiments, the names of nodes are chosen by a user from a database of allowed node names in order to ensure conformity in node names. In some embodiments, the names of node inputs 310 and outputs 316 are also chosen by a user from a database of allowed node input and output names in order to ensure conformity in node input and output names. In some embodiments, the names of node input properties 312 and node output properties 318 are also chosen by a user from a database of allowed node input property names and node output property names in order to ensure their conformity.

To illustrate a set of parameterized resource inputs 308, in some embodiments, the set of parameterized resource inputs 308 for a node 304 in the plurality of nodes of a process hypergraph 302 comprises a first 310-1 and second parameterized resource input 310-2. The first parameterized resource input specifies a first resource and is associated with a first input property 312-1 (508). The second parameterized resource input 310-2 specifies a second resource and is associated with a second input property 312-2. In some embodiments, the first input property is different than the second input property.

In some embodiments, the set of parameterized resource inputs 308 for a node 304 in the plurality of nodes comprises a first parameterized resource input 310. The first parameterized resource input 310 specifies a first resource and is associated with a first input property 312 and a second input property 312. The first input property is different than the second input property (510).

In some embodiments, the first input property is a viscosity value, a purity value, composition value, a temperature value, a weight value, a mass value, a volume value, or a batch identifier of the first resource (512). FIG. 6 illustrates. Node 304-4 “Fermenter Setup” includes in its associated set of parameterized resource inputs 308 a fermenter 310-4 and a waste bottle 310-6 among other resource inputs. Although not shown in FIG. 6, the fermenter 310-4 is associated with a first input property, such as a size of the fermenter or a fermenter make/model number. Furthermore, the waste bottle 310-6 is associated with a second input property, such as a size of the waste bottle 310-6 or a waste bottle 310-6 make and model number.

In some embodiments a resource input 310 is a single resource. For instance, in FIG. 6, resources 310-1 through 310-11 are all examples of single resources. In some embodiments, a resource input 310 is a composite resource. Examples of composite resources include, but are not limited, to mixtures of compositions (e.g., media, broth, etc.) and multi-component equipment.

In some embodiments, the set of parameterized resource inputs 308 for a first node 304 in the plurality of nodes of a process hypergraph 302 comprises a first parameterized resource input 310 and this first parameterized resource input specifies a process condition associated with the corresponding stage of the process associated with the first node 304 (514). For example, in some embodiments, this process condition specifies an intensive quantity, an extensive quantity, a temperature, a volume, time, a space, a quality, a type of equipment, an order, a state, or a batch identifier (516).

As noted above in some embodiments, for a given node, at least one of the parameterized resource outputs in the set of parameterized resource outputs for the node is associated with one or more output properties, and in some such embodiments the one or more output properties includes a corresponding output specification limit. In some embodiments, this corresponding output specification limit comprises a nominal value, an upper limit, and/or a lower limit for the corresponding parameterized resource output (518). To illustrate, an example of an output property is pH of a composition. In such an example, the output specification limit specifies the allowed upper limit for the pH of the composition and the allowed lower limit for the pH of the composition. In alternative embodiments, this corresponding output specification limit comprises an enumerated list of allowable types (520). To illustrate, an example of an output property is a crystallographic orientation of a material. In such an example, the output specification limit specifies an enumerated list of allowed crystallographic orientations for material.

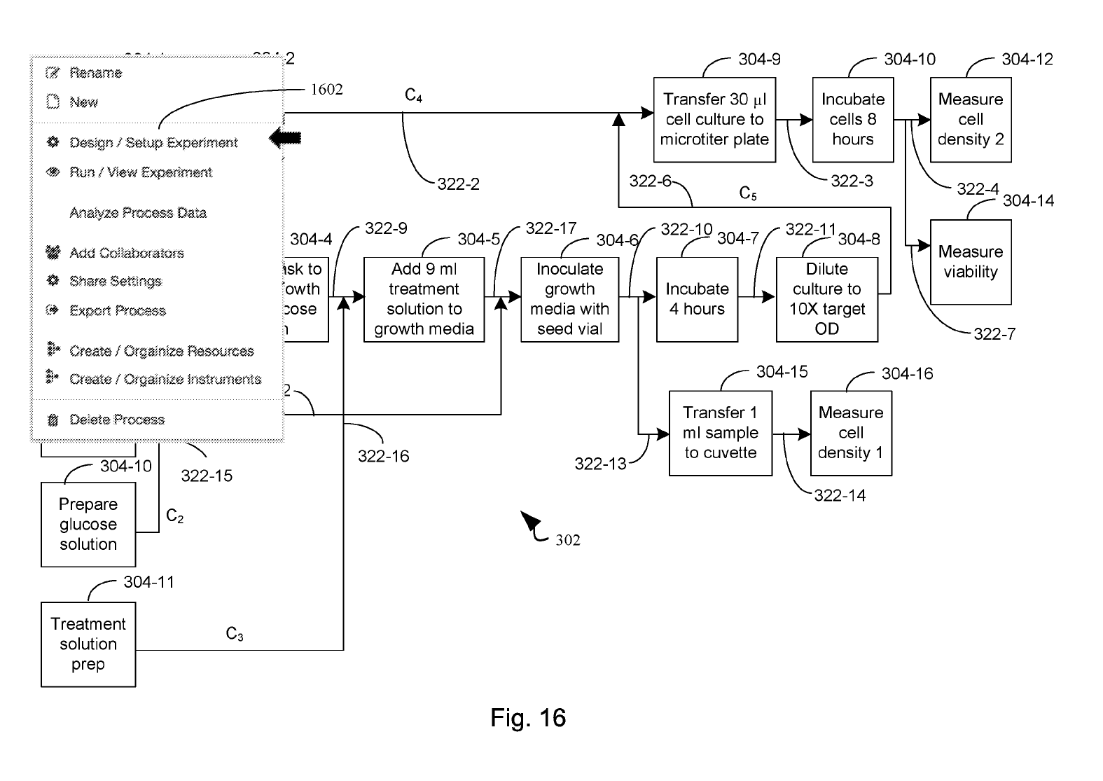

Referring to block 522 of FIG. 5C, the process continues by identify a plurality of factors 226. Each respective factor 402 in the plurality of factors 226 is associated with: (i) an input property 312 in the one or more input properties of a resource input 310 in the set of parameterized resource inputs 308 of a corresponding node 304 in the plurality of nodes, or (ii) an output property 318 in the one or more output properties of a resource output 316 in the set of parameterized resource outputs 315 of a corresponding node in the plurality of nodes. FIGS. 16 and 17 illustrate. In FIG. 16, the menu option Design/Setup experiment 1602 is selected by a user or is autonomously initiated. FIG. 16 illustrates a process hypergraph comprising a plurality of nodes 304 and a plurality of process edges. Each respective process edge in the plurality of process edges specifies the set of parameterized resource outputs of a node (parent node) in the plurality of nodes that is included in the set of parameterized resource inputs of at least one other node (child node) in the plurality of nodes and identifies the at least one other node. In FIG. 17, three factors, “strain” 402-1, “type” 402-2, and “absorbance @550 nm” 402-3 are selected. As illustrated in FIG. 17, each of these three factors is associated with a corresponding node 304 and specifies (i) an input property 312 in the one or more input properties of a resource input 310 in the set of parameterized resource inputs 308 of the corresponding node or (ii) an output property 318 in the one or more output properties of a resource output 316 in the set of parameterized resource outputs 315 of the corresponding node. Thus, in FIG. 17, the factor 402-1 specifies the output property 318 “strain” of the corresponding node 304-9 “Thaw 1 ml seed vial.” The factor 402-2 specifies the output property 318 “type” of the corresponding node 304-5 “Add 9 ml treatment solution to growth media.” The factor 402-3 specifies the output property 318 “absorbance @550 nm” of the corresponding node 304-9 “Thaw 1 ml seed vial.”

Next, referring to block 544, there is identified, for each respective factor 402 in the plurality of factors, a number of levels 404 for the input property 312 or output property 318 associated with the respective factor. FIG. 17 illustrates. Levels “RF342” and “RF480” are identified for the output property 318 “strain” specified by factor 402-1. Levels “Halyronate,” “citrate,” and “GABA” are identified for the output property 318 “type” specified by the factor 402-2. Levels “0.1,” “0.12” and 0.25” are specified for the output property 318 “absorbance @550 nm” specified by the factor 402-3.

Referring to block 526, in some embodiments, a factor 402 in the plurality of factors is a continuous factor, a discrete numeric factor, or a categorical factor. For instance, referring to FIG. 17, levels “RF342” and “RF480” are identified for the output property 318 “strain” specified by factor 402-1 and thus factor 402-1 is a categorical factor. Levels “0.1,” “0.12” and 0.25” are specified for the output property 318 “absorbance @550 nm” specified by the factor 402-3 and thus the factor 402-3 is a discrete numeric factor. An example of a factor that is a continuous factor would be one where the input property or output property specified by the factor is associated with a range of levels such as any number in the range 0 to 100.

Referring to block 528 of FIG. 5C, the method continues by defining a plurality of parameter combinations 228. Each parameter combination in the plurality of parameter combinations is: (i) assigned a unique parameter combination identifier 408 from a plurality of unique parameter combinations identifiers, and (ii) includes an instance of each factor 402 in the plurality of factors, where each respective factor 402 in the instance of the plurality of factors is set to a level 404 in the number of levels of the property 312/318 associated with the respective factor. FIG. 18 illustrates with respect to the plurality of factors 226: “seed vial,” “treatment chemical type,” “incubation time (h),” and “culture initial OD.” As illustrated in FIG. 18, the respective factor 402 that specifies the output property 318 “seed vial” is associated with node 304-9 and there are two possible levels 404 for this property “Strain 1” and Strain 2.” Thus, each parameter combination 406 includes one of these two levels for the respective factor. As illustrated in FIG. 18, the respective factor 402-1 specifies the property “seed vial” and is associated with node 304-9 and there are two possible levels 404 for this property “Strain 1” and Strain 2.” Thus, each parameter combination 406 includes one of these two levels for the respective factor 402-1. As illustrated in FIG. 18, the respective factor 402-2 specifies the property “Treatment Chemical Type” and is associated with node 304-5 and there are three possible levels 404 for this property “Halyuronate,” “GABA,” and “Citrate.” Thus, each parameter combination 406 includes one of these three levels for the respective factor 402-2. As illustrated in FIG. 18, the respective factor 402-3 specifies the property “Incubation time (h)” and is associated with node 304-7 and there are two possible levels 404 for this property “two hours,” and “six hours.” Thus, each parameter combination 406 includes one of these two levels for the respective factor 402-3. As illustrated in FIG. 18, the respective factor 402-4 specifies the property “Culture Initial OD” and is associated with node 304-10 and there are three possible levels 404 for this property “0.01,” “0.1,” and “0.055.” Thus, each parameter combination 406 includes one of these three levels for the respective factor 402-4.

Referring to block 530 of FIG. 5C, in some embodiments the defining of a plurality of parameter combinations implements a full factorial design of the plurality of factors 226 to define the plurality of parameter combinations 228, where the plurality of parameter combinations collectively defines, for each respective factor 402 in the plurality of factors 226, the specified number of levels 404 of the specified property 312/318 associated with the respective factor. Thus, in such embodiments, the plurality of parameter combinations has a parameter combination 408 at every combinations of levels 404 of the factors 402. Thus, in such embodiments, the number of parameter combinations 406 equals the product of the numbers of factor levels 404 across the plurality of factors 226.

Referring to block 532 of FIG. 5C, in some embodiments the defining implements a fractional factorial design (e.g., a Taguchi design or a Latin Squares design) of the plurality of factors 226 to define the plurality of parameter combinations 228, where the plurality of parameter combinations 228 collectively defines, for each respective factor 402 in at least a subset of the plurality of factors, a subset of the levels 404 of the specified property 312/318 associated with the respective factor. Such fractional factorial design is used to study the factors 402 using a comparatively smaller allocation of resources than a full factorial design. For instance, in some embodiments factors 402 that are continuous are set at two different levels 404 (low and high) in a fractional design. In some embodiments, factors 402 that are continuous are set at three different levels 404 in a fractional design.

Referring to block 534 of FIG. 5D, in some embodiments the defining implements a D-optimal or I-optimal design algorithm to define the plurality of parameter combinations 228. Referring to block 536 of FIG. 5D, in some embodiments the defining implements a Fedorov algorithm to define the plurality of parameter combinations 228. See, for example, Fedorov, March and June 1994, “Optimal Experimental Design: Spatial Sampling,” Calcutta Statistical Association Bulletin Vol. 44, Nos. 173-174, which is hereby incorporated by reference.

Referring to block 538 of FIG. 5D, in some embodiments the defining is repeated until an exit condition (e.g., user acceptance of the plurality of parameter combinations, a power calculation based upon the plurality of parameter combinations satisfies a first threshold level) is satisfied. This is particularly the case when something less than a full factorial design is implemented. In some such embodiments, the user will review the plurality of parameter combinations, such as is presented in FIG. 18 and determine whether the factors 402 are being tested by the plurality of parameter combinations at suitable levels. If the user is not satisfied, the user may add or delete parameter combinations 406 from the plurality of parameter combinations and/or try a different factorial design approach until satisfied.

In some embodiments the creation of the plurality of parameter combinations is repeated and/or continued until the plurality of parameter combinations achieves a certain power calculation. Power calculations are used to determine the sample size required in to detect a meaningful scientific effect with sufficient power. For instance, in R (R Core Team, 2012, “R: A language and environment for statistical computing. R Foundation for Statistical Computing,” Vienna, Austria. ISBN 3-900051-07-0, URL R-project.org/, which is hereby incorporated by reference), there are functions to calculate either a minimum number of parameter combinations 506 needed for a specific power for a given plurality of factors.

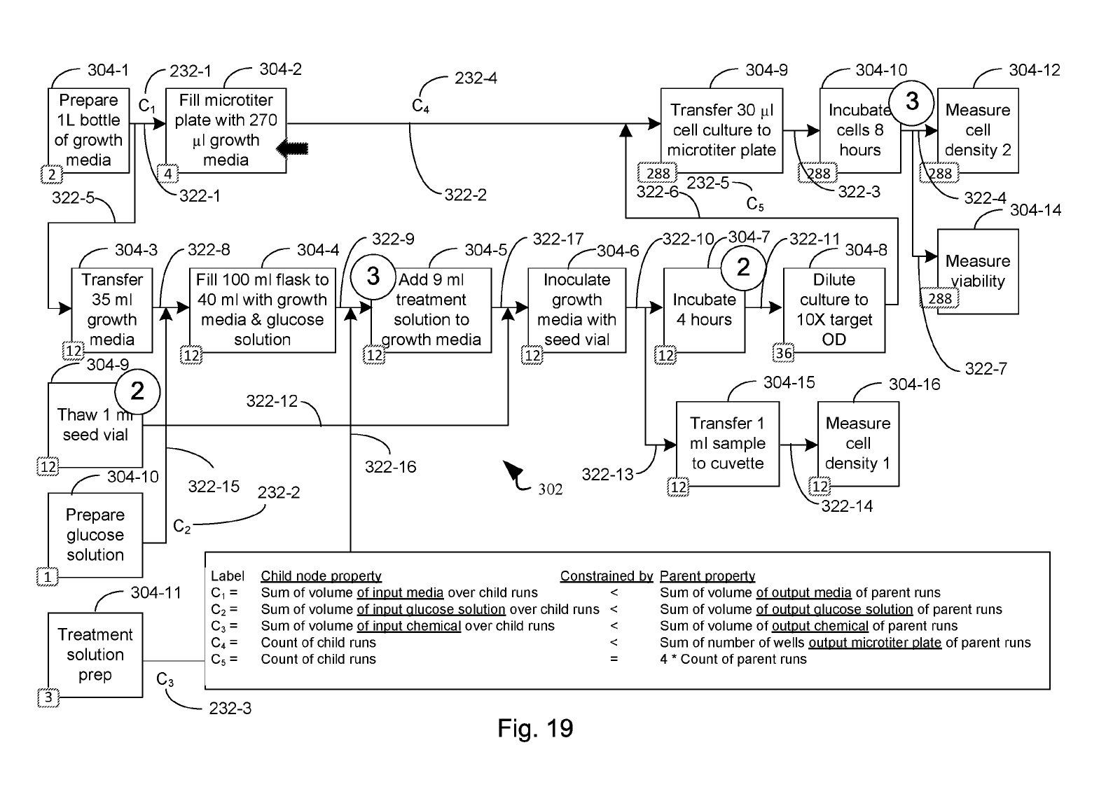

Referring to block 540 of FIG. 5D and with further reference to FIG. 19, the method continues by obtaining a plurality of run constraints 230. Each respective run constraint 232 in the plurality of run constraints 230 corresponds to a different parent node/child node pair in the plurality of nodes that are connected by a process edge in the plurality of process edges 322. Further, each respective run constraint 232 in the plurality of run constraints 230 specifies a relationship between a number of runs of the parent node to a number of runs for the child node for the corresponding parent node/child node pair.

Thus, referring to FIG. 19, run constraint 232-1 corresponds to the parent node/child node pair 304-1 “Prepare 1L bottle of growth media”/304-2 “Fill microtiter plate with 270 μl growth media” that are connected by the process edge 322-1. The run constraint 232-1 specifies a relationship between a number of runs 208 of the parent node 304-1 to a number of runs 208 for the child node 304-2 for the corresponding parent node/child node pair. Specifically run constraint 232-1 specifies that the sum of the volume of input media over the child runs (for the node 304-2) must be less than the sum of volume of output media of parent runs 208 (for node 304-1). Thus, run constraint 232-1 sets a limit between the number of runs of the parent node 304-1 to the number of runs of the child node 304-2.

Run constraint 232-2 corresponds to the parent node/child node pair 304-10 “Prepare glucose media”/304-4 “Fill 100 ml flask to 40 ml with growth media & glucose solution” that are connected by the process edge 322-15. The run constraint 232-2 specifies a relationship between a number of runs 208 of the parent node 304-10 to a number of runs 208 for the child node 304-4 for the corresponding parent node/child node pair. Specifically run constraint 232-2 specifies that the sum of the volume of input glucose solution over the child runs (for the node 304-4) must be less than the sum of volume of output glucose solution of parent runs 208 (for node 304-10). Thus, run constraint 232-2 sets a limit between the number of runs of the parent node 304-10 and the number of runs of the child node 304-4.

Run constraint 232-3 corresponds to the parent node/child node pair 304-11 “Treatment solution prep”/304-5 “Add 9 ml treatment solution to growth media” that are connected by the process edge 322-16. The run constraint 232-3 specifies a relationship between a number of runs 208 of the parent node 304-11 to a number of runs 208 for the child node 304-5 for the corresponding parent node/child node pair. Specifically run constraint 232-3 specifies that the sum of the input chemical over the child runs (for the node 304-5) must be less than the sum of volume of output chemical of parent runs 208 (for node 304-11). Thus, run constraint 232-3 sets a limit between the number of runs of the parent node 304-11 and the number of runs of the child node 304-5.

Run constraint 232-4 corresponds to the parent node/child node pair 304-2 “Fill microtiter plate with 270 μL growth media”/304-9 “Transfer 30 μl cell culture to microtiter plate” that are connected by the process edge 322-4. The run constraint 232-4 specifies a relationship between a number of runs 208 of the parent node 304-2 to a number of runs 208 for the child node 304-9 for the corresponding parent node/child node pair. Specifically, run constraint 232-4 specifies that the count of the number of child runs (for the node 304-9) must be less than the sum of the number of wells outputted by microtiter plates in the parent runs 208 (for node 304-2). Thus, run constraint 232-4 sets a limit between the number of runs of the parent node 304-2 and the number of runs of the child node 304-9.

Run constraint 232-5 corresponds to the parent node/child node pair 304-8 “Dilute culture to 10× target OD”/304-9 “Transfer 30 μl cell culture to microtiter plate” that are connected by the process edge 322-5. The run constraint 232-5 specifies a relationship between a number of runs 208 of the parent node 304-8 to a number of runs 208 for the child node 304-9 for the corresponding parent node/child node pair. Specifically, run constraint 232-5 specifies that the count of the number of child runs (for the node 304-9) must be less than four times the count of the parent runs 208 (for node 304-8). Thus, run constraint 232-5 sets a limit between the number of runs of the parent node 304-9 and the number of runs of the child node 304-8.

Referring to block 542 of FIG. 5D, in some embodiments a first run constraint 232 in the plurality of run constraints 230 is an equality or inequality property imposed between the output of the parent node and the input of the child node in the parent node/child node pair associated with the first run constraint. Constraints 232-1 through 232-5 of FIG. 19 demonstrate such constraints.

Referring to block 544 of FIG. 5D, in some embodiments a first run constraint 232 in the plurality of run constraints 230 is a mass balance inequality constraint between the output of the parent node and the input of the child node in the parent node/child node pair associated with the first run constraint.

Referring to block 546 of FIG. 5D, in some embodiments a first run constraint 232 in the plurality of run constraints 230 is a one-to-one, many-to-one, or one-to-many relationship between (i) the number of runs of the parent node and (ii) the number of runs for the child node for the corresponding parent node/child node pair.

Referring to block 548 of FIG. 5E, the method continues with the building of the run hypergraph 204. Each respective run 208 in the plurality of runs for the run hypergraph comprises: (i) an index 206 to a corresponding node in the plurality of nodes, (ii) a run identifier 210, and (iii) a parameter combination identifier 408 of a parameter combination 406 in the plurality of parameter combinations 228.

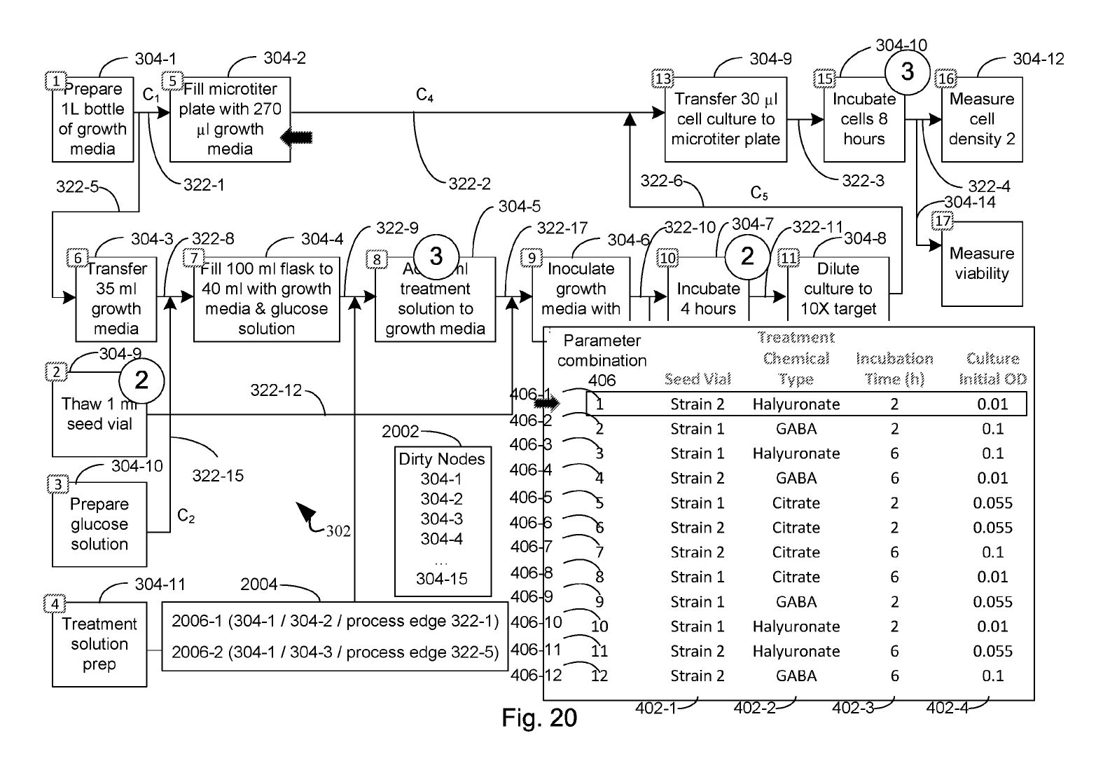

Referring to block 550 of FIG. 5E, in some embodiments each respective run 208 in the plurality of runs further comprises a flag 214 that specifies whether the respective run is marked “included,” and the building 548 comprises: for each respective parameter combination 406 in the plurality of parameter combinations 228, performing a first enumeration process comprising: (a) adding each node 304 in the plurality of nodes to a first data structure, (b) removing a first node in the first data structure and performing a second enumeration process for the first node when the first data structure is not empty, and (c) repeating step (b) of the first enumeration process until the first data structure is empty. Thus, the first enumeration process operates on each node in the process hypergraph 304 when building the run hypergraph 204. FIG. 20 illustrates. In FIG. 20, each node 304 in the plurality of nodes is added to a first data structure 2002. Then, a first node in the plurality of nodes is removed from the first data structure and a second enumeration process is performed on the first node. It will be appreciated that, as used in this context, there is no requirement that the first node be physically removed from the first data structure 2002. That is, to affect the step of “removing the node from the first data structure,” in fact, the node may simply be flagged or otherwise denoted as removed rather than actually removing the node from the first data structure 2002. That is, the terminology of specifying that the first node is removed from the first data structure is simply used to convey in a straightforward manner that the first node will be operated upon by the second enumeration process. In some embodiments, the second enumeration process, or a process called by the second enumeration process will add the first node back to the first data structure and thus the first node may be operated upon any number of times by the second enumeration process.

Referring to block 552 of FIG. 5E, in some embodiments the second enumeration process for the first node 204 comprises: (a) adding each parent-child or child-parent node relationship with the first node through a process edge 322 in the plurality of process edges to a parent node-child node connection data structure 2004, and (b) for each respective parent node-child node connection from the connection data structure, removing the respective parent node-child node connection from the connection data structure and performing a third enumeration process for the respective parent node-child node. Thus, referring to FIG. 20, if the first node is deemed to be node 304-1, each parent-child or child-parent node relationship with the first node through a process edge 322 in the plurality of process edges is added to a parent node-child node connection data structure 2004. Namely, (i) the parent-child node relationship 2006-1 (304-1/304-2 through process edge 322-1) and (ii) the parent-child node relationship 2006-2 (304-1/304-3 through process edge 322-5) are added to the connection data structure 2004. Then, a respective parent-child or child-parent node relationship 2006 with the first node is removed from the parent node-child node connection data structure 2004 and a third enumeration process is performed on the respective parent-child or child-parent node relationship 2006. It will be appreciated that as used in this context, there is no requirement that the respective parent-child or child-parent node relationship 2006 be physically removed from the parent node-child node connection data structure. That is, to affect the step of “removing the respective parent-child or child-parent node relationship 2006 from the parent node-child node connection data structure 2004,” in fact, the respective parent-child or child-parent node relationship 2006 may simply be flagged or otherwise denoted as removed rather than actually removing the respective parent-child or child-parent node relationship 2006 from the parent node-child node connection data structure 2004. That is, the terminology of specifying that the respective parent-child or child-parent node relationship 2006 is removed from the parent node-child node connection data structure 2004 is simply used to convey in a straightforward manner that the respective parent-child or child-parent node relationship 2006 will be operated upon by the third enumeration process.

Referring to block 554 of FIG. 5F, in some embodiments the third enumeration process for the respective parent node-child node connection 2006 comprises first checking to see if there is a qualifying run for the parent node in the parent node-child node connection 2006. Specifically, (a) adding a respective run 208 to the plurality of runs of the run hypergraph 204, where the respective run is (i) marked with the identifier 408 for the respective parameter combination 406 (specified by block 550), (ii) associated with the parent node 304, and (iii) includes a level 404 for a factor 402 (e.g., for an input or output property 312/318 specified by the factor) for the parent node 304 that is specified by the respective parameter combination 406, when no such run 208 is present in the plurality of runs of the run hypergraph 204, where, when a respective run is added in (a), the parent node 304 is added to the first data structure 2002. Thus, referring to FIG. 20, when block 550 specifies a particular parameter combination 406, step (a) of the exemplary third enumeration process checks to see if there exists a run 206 in the run hypergraph associated with the parent node of the respective parent node-child node connection 2006 with a level 404 for a property of a factor 402 for the parent node 304 that is specified by the respective parameter combination 406 and adds such a run to the run hypergraph when such a run does not exists.

In some embodiments the third enumeration process for the respective parent node-child node connection 2006 also comprises checking to see if there is a qualifying run for the child node in the parent node-child node connection 2006. Specifically, (b) adding a respective run 208 to the plurality of runs of the run hypergraph 204, where the respective run is (i) marked with the identifier 408 for the respective parameter combination 406, (ii) associated with the child node 304, and (iii) includes a level 404 (e.g., for an input or output property 312/318 specified by the factor) for a factor 402 for the child node 304 that is specified by the respective parameter combination 406, when no such run 208 is present in the plurality of runs, where, when a respective run is added in (b), the child node 304 is added to the first data structure 2002. Thus, referring to FIG. 20, when block 550 specifies a particular parameter combination 406, step (b) of the exemplary third enumeration process checks to see if there exists a run 206 in the run hypergraph 204 that is associated with the child node of the respective parent node-child node connection 2006 with a level 404 for a property of a factor 402 for the child node 304 that is specified by the respective parameter combination 406 and adds such a run to the run hypergraph 204 when such a run does not exists.

Thus, at least upon completion of steps (a) and (b) of the third enumeration process, there exists (i) a run 208 associated with the parent node 304 of the respective parent node-child node connection 2006 that specifies a level 404 for a property of a factor 402 associated with the parent node 304 in the parameter combination 406 specified in block 550 and (ii) a run 208 associated with the child node 304 of the respective parent node-child node connection 2006 that specifies a level 404 for a property of a factor 402 associated with the child node 304 in the parameter combination 406 specified in block 550. In step (c) of the third enumeration process, a subset of runs in the plurality of runs from a bipartite subgraph of the run hypergraph 204 including the parent node 304 and the child node that are (i) associated with the parent node and include a level for (a property of) a factor for the parent node that is specified by the respective parameter combination 406 or (ii) associated with the child node 304 and include a level for (a property of) a factor for the child node that is specified by the respective parameter combination are obtained. Such a selection will at least include (i) runs 208 associated with the parent node 304 of the respective parent node-child node connection 2006 that specify a level 404 for a property of a factor 402 associated with the parent node 304 in the parameter combination 406 specified in block 550 and (ii) runs 208 associated with the child node 304 of the respective parent node-child node connection 2006 that specifies a level 404 for a property of a factor 402 associated with the child node 304 in the parameter combination 406 specified in block 550. Step (d) of the third enumeration process calls for aborting the third enumeration process when each run 208 in the subset of runs of step (c) is marked as “included.” In some embodiments, the include flag 214 is used to denote whether a run is include or not, although any means for tracking whether a run is included may be used and is encompassed within the scope of the present disclosure. In step (e) of the third enumeration process, there is run for each respective run in the subset of runs that has not been marked as “included,” a fourth enumeration process.

Referring to block 556 of FIG. 5G, in some embodiments, the fourth enumeration process for the respective run 208 comprises (a) marking the respective run 208 as “active.” In some embodiments, this is done by setting flag 216 of the respective run, although the present disclosure encompasses and equivalent way of marking the respective run 208 as “active.” Further, in step (b) there is marked as “active” any run 208 in the subset of runs identified in the calling third enumeration process of block 554 that are (i) connected to the respective run by a run edge 218 in the plurality of run edges of the run hypergraph or a combination of run edges in the plurality of edges. In step (c) of the exemplary fourth enumeration process, there is identified within the plurality of runs or added to the plurality of runs of the run hypergraph 204, one or more runs indexed to the parent node or the child node (associated with the respective parent node-child node connection specified by the third enumeration process of block 554) that specifies the level 404 for (the property 312/318) of the factor 402 specified by the respective parameter combination 406 for the respective parent node or child node, when the respective run constraint 232 in the plurality of run constraints between the parent node and the child node is not satisfied by the runs in the plurality of runs that are marked as “active,” thereby satisfying the respective run constraint 232. For instance, consider run constraint 232-1 between nodes 304-1 and 304-2 illustrated in FIG. 19. If the run constraint 232-1 is not satisfied, runs indexed to the parent node 304-1 or the child node 304-2 that specifies the level 404 for (the property 312/318) of the factor 402 specified by the respective parameter combination 406 for the respective parent node or child node are added until the run constraint is satisfied.

A general algorithm for computing the runs required in order to satisfy a set of equality and inequality constraints such as the plurality of run constraints 230 on runs 208 of nodes in a process follows. This is a general algorithm class that answers the question “how many runs of each step are needed to satisfy a run ratio or run inequality specified by a run constraint 232?” and can be applied to any set or subset of nodes in a run hypergraph 204 (e.g., all the nodes of the process embodied by the run hypergraph or somewhere in between). The problem of generating runs subject to constraints can be posed as an integer linear program (ILP). The canonical form of the ILP is:
maximize c^{T}x
subject to Ax+s=b,
   s≥0,
and x∈ [symbol] ⁿ,

where,

x is vector, of which each element in x corresponds to the number of runs of that node, thus each element must be an integer greater than zero,

A is a matrix having integer values,

b is a vector holding integer values,

s is a vector holding integer values,

A, b, s, x, together define the equalities and inequalities imposed on the system by the plurality of run constraints 230.

This canonical problem can be solved using methods such as cutting-place, branch and bound, branch and cut, branch and price.

One algorithm for analytically computing runs required in order to satisfy run ratios is as follows. Consider nodes A and B, with a run ratio of rA:rB imposed by a run constrain 232, where rA and rB are the required ratios of numbers of runs 208 for each node 304. Define nA and nB as the required number of runs, to be calculated. Assume there are existing runs for each node, denoted nA0, nB0. If nA0/nB0≠rA/rB, then more runs of A and/or B are required. First, compute a new lower limit on the required number of runs of A and B, denoted as nA1 and nB1, respectively, using the ceiling operator to round up values to the nearest integer. Compute nA1=rA*ceiling(nA0/rA). Compute nB1=rB*ceiling(nB0/rB). Then select the appropriate case to evaluate:

1) If nA1/nB1=rA/rB, then nA=nA1 and nB=nB1

2) If nA1/nB1>rA/rB, then nA=nA1 and nB=nA1*rB/rA

3) If nA1/nB1<rA/rB, then nA=nB1*rA/rB and nB=nB1

Finally, add (nA−nA0) runs of step A and (nB−nB0) runs of step B

As an example, consider the scenario:

rA=3

rB=2

nA0=7

nB0=3

Compute nA1 and nB1:

nA1=3*ceiling(7/3)=9

nB1=2*ceiling(3/2)=4

Here, case two from the algorithm above applies, because nA1/nB1=9/4>3/2=rA/rB. So: nA=9, nB=6. So, add two runs to node A and 3 runs to node b.

In step (d) of the fourth enumeration process, there is marked as “active” all runs identified or added in step (c) of the fourth enumeration process, where, when runs are added to the parent node or the child node in step (c) of the fourth enumeration process, the parent node or the child node is added back to the first data structure 2002. In step (e) of the fourth enumeration process all runs identified or added in step (c) of the fourth enumeration process are linked to all parent runs or child runs in the subset of runs that are marked as “active” by assigning each run, identified or added in step (c) with a run edge 218, to a parent run (i.e., associated with the parent node) or a child run (i.e., associated with the child node) in the subset of runs that is marked as “active.” In step (f) of the fourth enumeration process all runs in the plurality of runs that are marked “active,” are marked as “included” and the “active” label is cleared from all runs in the plurality of runs in the run hypergraph 204.

Thus, by the recursive application of the first through fourth enumeration processes a run hypergraph is built from a plurality of parameter combinations for a process subject to a plurality of run constraints for the process.

In some embodiments there are additions and/or variants to the process described in conjunction with FIGS. 5A through 5G. For instance, in some embodiments, one or more runs 208 are added to the plurality of runs of the run hypergraph 204 prior to performing building block 548 or contemporaneously with performing building block 548. For instance, such runs 208 may represent preexisting runs or runs added by a user. In some such embodiments, a set of runs is obtained. Each run in the set of runs is associated with a respective node 304 in the plurality of nodes. A subset of the runs in the set of runs is joined, where each run in the subset of runs is linked to at least one other run in the subset of runs by a run edge 218 included in or added to the plurality of run edges of the run hypergraph 204. Each run in the subset of runs is assigned with the parameter combination identifier 408 of a parameter combination 406 in the plurality of parameter combinations 228 when the subset of runs includes a respective run 208 for each respective factor 402 in the plurality of factors 226 at the respective level 404 specified in the parameter combination 228 for the respective factor 402. The subset of runs is then removed from the set of runs and this process is repeated until an exit condition is achieved. Then, each run 208 that has been assigned a parameter combination identifier 408 by this procedure is added to the plurality of runs of the run hypergraph 204. In some such embodiments, each run in the set of runs specifies a level for a factor for the respective node corresponding to the factor. In some such embodiments, the set of runs are created by a user. In some such embodiments, the exit condition is depletion of the set of runs.

In alternative embodiments, one or more runs 208 are added to the plurality of runs of the run hypergraph 204 prior to performing building block 548 or contemporaneously with performing building block 548. In these alternative embodiments, such runs 208 may represent preexisting runs or runs added by a user. In such embodiments, a set of runs is obtained, where each run in the set of runs is associated with a respective node in the plurality of nodes of the run hypergraph 204. A subset of runs in the set of runs is joined, where each run in the subset of runs is linked to at least one other run in the subset of runs by a run edge 218 included in or added to the plurality of run edges. The subset of runs is removed from the set of runs and this process is repeated until an exit condition is achieved, thereby achieving a plurality of subsets of runs. Each subset of runs includes a level of a property 312/318 in the plurality of properties and thus potentially may be grouped with one of the plurality of parameter combinations 228 defined in block 528 of FIG. 5C. To see if this is the case, the levels 404 of the properties 312/318 in each respective subset of runs is treated as the elements of a corresponding respective vector as are the levels of the properties in each respective parameter combination 406 defined in block 528. In this way, each subset of runs in the plurality of subsets of runs that includes a run for each factor in the plurality of factors 226 can be co-clustered with the plurality of parameter combinations 228, where the co-clustering produces a plurality of clusters, and where each cluster in the plurality of clusters includes a parameter combination 406 (e.g., at most one such a parameter combination 406 though other embodiments allow more than one such parameter combination 406 in a single cluster) in the plurality of parameter combinations 228. Each run in the plurality of subsets of runs that co-clusters with a respective parameter combination 406 is assigned the parameter combination identifier 408 assigned to the respective co-clustered parameter combination 406 and the runs that have been assigned a parameter combination identifier 408 are added to the plurality of runs of the run hypergraph 204. In some such embodiments, each run in the set of runs specifies a level for a factor for the respective node corresponding to the factor. In some such embodiments, the set of runs are created by a user. In some such embodiments, the co-clustering is performed by k-means clustering or hierarchical clustering based on a distance metric (e.g., a Euclidian distance metric, a Hamming distance metric, or a correlation).

In some embodiments, the method further comprises pruning the plurality of runs by counting a number of runs at each node in the plurality of nodes that have the same assigned parameter combination identifier. For instance, in some embodiments, working down the process flow of the run hypergraph 204 from node 304 to node 304 by traversing run edges 218, all runs 208 with a common parent run that share the same property values are collapsed into a minimum set of runs that still satisfy all run constraints 232.

### EXAMPLE EMBODIMENT

1) A user selects (a) properties of resources on nodes 304 (a.k.a., factors, variables) to be varied, (b) the desired test levels 404 for each factor 402, and (c) design of experiment algorithm parameters.

2) A user executes a design of experiment (DOE) algorithm. The DOE algorithm generates a design matrix of parameter combinations across nodes (plurality of parameter combinations 228) using, for example a D-optimal or I-optimal design algorithm such as the Fedorov algorithm implemented, for example, in R. The DOE algorithm also generates design evaluation information such as the Power of the design and the number of runs. The user iterates on DOE design matrix using design evaluation info until satisfied with the plurality of parameter combinations 228.

3) The user defines run constraints 232 on the run edges 218 between nodes 204 in the run hypergraph 204 that relate the number of runs 208 on an upstream node 304 to the number of runs on a downstream node. In some embodiments, the run constrain 232 may or may not be specified explicitly in terms of run counts.

4) The user executes a run enumeration procedure thus building out the run hypergraph 204. In phase 1, which is optional, a first analysis algorithm checks existing runs for matching parameter combinations in the DOE design matrix (e.g., in the plurality of parameter combinations 228). The algorithm associates the runs to matching parameter combinations (if found). In phase 2, a run enumeration algorithm generates a set of runs on the entire process that satisfy (A) the DOE design matrix parameter combinations (the plurality of parameter combinations 228 and (B) the plurality of run constraints 230. In phase 3, a second analysis algorithm checks final set of runs for balance (specifically, it checks if each DOE parameter combination in the plurality of parameter combinations 228 is represented the same number of times in the final run set). The algorithm tags a balanced subset of runs. In phase 4, a run pruning algorithm attempts to find the most parsimonious run set by combining runs with shared parameter values while still satisfying the DOE design matrix (the plurality of parameter combinations 228) and the plurality of run constraints 230. A user can modify runs. In some embodiments, any change in a number of runs, run constraint 232, or node addition/removal will cause re-run of the run enumeration algorithm to ensure the DOE (plurality of parameter combinations 228) and run constraints 232 are satisfied. In some embodiments, a user can turn-off automatic re-run, or set the mode to ‘check only’ which will run only phase 1 of the enumeration algorithm only.

### REFERENCES CITED AND ALTERNATIVE EMBODIMENTS

All references cited herein are incorporated herein by reference in their entirety and for all purposes to the same extent as if each individual publication or patent or patent application was specifically and individually indicated to be incorporated by reference in its entirety for all purposes.

The present invention can be implemented as a computer program product that comprises a computer program mechanism embedded in a nontransitory computer readable storage medium. For instance, the computer program product could contain the program modules shown in any combination of FIGS. 1, 2, 3, and/or 4. These program modules can be stored on a CD-ROM, DVD, magnetic disk storage product, or any other tangible computer readable data or program storage product.

Many modifications and variations of this invention can be made without departing from its spirit and scope, as will be apparent to those skilled in the art. The specific embodiments described herein are offered by way of example only. The embodiments were chosen and described in order to best explain the principles of the invention and its practical applications, to thereby enable others skilled in the art to best utilize the invention and various embodiments with various modifications as are suited to the particular use contemplated. The invention is to be limited only by the terms of the appended claims, along with the full scope of equivalents to which such claims are entitled.

1. A non-transitory computer readable storage medium for building a run hypergraph from a plurality of parameter combinations for a process subject to a plurality of run constraints for the process, wherein
the run hypergraph comprises (i) a plurality of nodes, (ii) a plurality of runs, each run in the plurality of runs being associated with a node in the plurality of nodes, and (iii) a plurality of run edges,
each run edge joins (a) a run in the plurality of runs associated with a parent node in the plurality of nodes and (b) a run in the plurality of runs associated with a child node in the plurality of nodes,
the process results in a product or analytical information, and
the non-transitory computer readable storage medium stores instructions, which when executed by a first device, cause the first device to perform a method comprising:
(A) obtaining a process hypergraph for the process, the process hypergraph comprising the plurality of nodes connected by process edges in a plurality of process edges, wherein
each respective node in the plurality of nodes is associated with:
(i) a set of parameterized resource inputs to the respective node, wherein at least one parameterized resource input in the set of parameterized resource inputs is associated with one or more input properties, the one or more input properties including an input specification limit, and
(ii) a set of parameterized resource outputs to the respective node, wherein at least one parameterized resource output in the set of parameterized resource outputs is associated with one or more output properties, the one or more output properties including a corresponding output specification limit, and
each respective process edge in the plurality of process edges specifies the set of parameterized resource outputs of a node (parent node) in the plurality of nodes that is included in the set of parameterized resource inputs of at least one other node (child node) in the plurality of nodes and identifies the at least one other node;
(B) identifying a plurality of factors, wherein each respective factor in the plurality of factors is associated with:
(i) an input property in the one or more input properties of a resource input in the set of parameterized resource inputs of a corresponding node in the plurality of nodes, or
(ii) an output property in the one or more output properties of a resource output in the set of parameterized resource outputs of a corresponding node in the plurality of nodes;
(C) identifying, for each respective factor in the plurality of factors, a number of levels for the input property or output property associated with the respective factor;
(D) defining the plurality of parameter combinations, wherein each parameter combination in the plurality of parameter combinations is:
(i) assigned a unique parameter combination identifier from a plurality of unique parameter combinations identifiers, and
(ii) includes an instance of each factor in the plurality of factors, wherein each respective factor in the instance of the plurality of factors is set to a level in the number of levels of the property associated with the respective factor;
(E) obtaining the plurality of run constraints, wherein
each respective run constraint in the plurality of run constraints corresponds to a different parent node/child node pair in the plurality of nodes that are connected by a process edge in the plurality of process edges, and
each respective run constraint in the plurality of run constraints specifies a relationship between a number of runs of the parent node to a number of runs for the child node for the corresponding parent node/child node pair; and
(F) building the run hypergraph, wherein each respective run in the plurality of runs comprises: (i) an index to a corresponding node in the plurality of nodes, (ii) a run identifier, and (iii) a parameter combination identifier of a parameter combination in the plurality of parameter combinations.

2. The non-transitory computer readable storage medium of claim 1, wherein each respective run in the plurality of runs further comprises (iv) a flag that specifies whether the respective run is marked included, and the building (F) comprises:
for each respective parameter combination in the plurality of parameter combinations, performing a first enumeration process comprising:
(a) adding each node in the plurality of nodes to a first data structure,
(b) removing a first node in the first data structure and performing a second enumeration process for the first node when the first data structure is not empty, and
(c) repeating step (b) of the first enumeration process until the first data structure is empty; and
wherein the second enumeration process for the first node comprises:
(a) adding each parent-child or child-parent node relationship with the first node through a process edge in the plurality of process edges to a parent node-child node connection data structure, and
(b) for each respective parent node-child node connection from the connection data structure, removing the respective parent node-child node connection from the connection data structure and performing a third enumeration process for the respective parent node-child node,
wherein the third enumeration process for the respective parent node-child node connection comprises:
(a) adding a respective run to the plurality of runs, wherein the respective run is (i) marked with the identifier for the respective parameter combination, (ii) associated with the parent node, and (iii) includes a level for a factor for the parent node that is specified by the respective parameter combination, when no such run is present in the plurality of runs, wherein, when a respective run is added in (a), the parent node is added to the first data structure,
(b) adding a respective run, to the plurality of runs, wherein the respective run is (i) marked with the identifier for the respective parameter combination, (ii) associated with the child node, and (iii) includes a level for a factor for the child node that is specified by the respective parameter combination, when no such run is present in the plurality of runs, wherein, when a respective run is added in (b), the child node is added to the first data structure,
(c) obtaining a subset of runs in the plurality of runs from a bipartite subgraph of the run hypergraph including the parent node and the child node that are (i) associated with the parent node and include a level for a factor for the parent node that is specified by the respective parameter combination or (ii) associated with the child node and include a level for a factor for the child node that is specified by the respective parameter combination,
(d) aborting the third enumeration process when each run in the subset of runs is marked as “included,” and
(e) for each respective run in the subset of runs that has not been marked as “included,” perform a fourth enumeration process, and
wherein the fourth enumeration process for the respective run comprises:
(a) marking the respective run as “active,”
(b) marking as “active” any run in the subset of runs that are (i) connected to the respective run by a run edge in the plurality of run edges or a combination of run edges in the plurality of edges,
(c) identifying within the plurality of runs or adding to the plurality of runs, one or more runs indexed to the parent node or the child node that specifies the level for the factor specified by the respective parameter combination for the respective parent node or child node, when the respective run constraint in the plurality of run constraints between the parent node and the child node is not satisfied by the runs in the plurality of runs that are marked as “active,” thereby satisfying the respective run constraint,
(d) marking as “active” all runs identified or added in step (c) of the fourth enumeration process, wherein, when runs are added to the parent node or the child node in step (c) of the fourth enumeration process, the parent node or the child node is added back to the first data structure,
(e) linking all runs identified or added in step (c) of the fourth enumeration process to all parent runs or child runs in the subset of runs that are marked as “active” by assigning each run identified or added in step (c) with a run edge to a parent run or a child run in the subset of runs that is marked as “active,”
(f) marking as “included” all runs in the plurality of runs that are marked “active,” and
(g) clearing the “active” label from all runs in the plurality of runs.

3. The non-transitory computer readable storage medium of claim 1, wherein the plurality of nodes comprises five or more nodes.

4. The non-transitory computer readable storage medium of claim 1, wherein
the set of parameterized resource inputs for a node in the plurality of nodes comprises a first and second parameterized resource input,
the first parameterized resource input specifies a first resource and is associated with a first input property,
the second parameterized resource input specifies a second resource and is associated with a second input property, and
the first input property is different than the second input property.

5. The non-transitory computer readable storage medium of claim 1, wherein
the set of parameterized resource inputs for a node in the plurality of nodes comprises a first parameterized resource input,
the first parameterized resource input specifies a first resource and is associated with a first input property and a second input property, wherein the first input property is different than the second input property.

6. The non-transitory computer readable storage medium of claim 4, wherein the first input property is a viscosity value, a purity value, composition value, a temperature value, a weight value, a mass value, a volume value, or a batch identifier of the first resource.

7. The non-transitory computer readable storage medium of claim 1, wherein
the set of parameterized resource inputs for a first node in the plurality of nodes comprises a first parameterized resource input, and
an input property associated with the first parameterized resource input specifies a process condition associated with the corresponding node.

8. The non-transitory computer readable storage medium of claim 7, wherein the process condition comprises an intensive quantity, an extensive quantity, a temperature, a volume, time, a space, a quality, a type of equipment, an order, a state, or a batch identifier.

9. The non-transitory computer readable storage medium of claim 1, wherein the corresponding output specification limit comprises a nominal value, an upper limit or a lower limit for an output property of a corresponding parameterized resource output.

10. The non-transitory computer readable storage medium of claim 1, wherein the corresponding output specification limit comprises an enumerated list of allowable types or states.

11. The non-transitory computer readable storage medium of claim 1, wherein a factor in the plurality of factors is a continuous factor, a discrete numeric factor, or a categorical factor.

12. The non-transitory computer readable storage medium of claim 1, wherein the defining (D) implements a full factorial design of the plurality of factors to define the plurality of parameter combinations, wherein the plurality of parameter combinations collectively defines, for each respective factor in the plurality of factors, the specified number of levels of the specified property associated with the respective factor.

13. The non-transitory computer readable storage medium of claim 1, wherein the defining (D) implements a fractional factorial design of the plurality of factors to define the plurality of parameter combinations, wherein the plurality of parameter combinations collectively defines, for each respective factor in at least a subset of the plurality of factors, a subset of the levels of the specified property associated with the respective factor.

14. The non-transitory computer readable storage medium of claim 13, wherein the fractional factorial design is a Taguchi design or a Latin Squares design.

15. The non-transitory computer readable storage medium of claim 1, wherein the defining (D) implements a D-optimal or I-optimal design algorithm to define the plurality of parameter combinations.

16. The non-transitory computer readable storage medium of claim 1, wherein the defining (D) implements a Fedorov algorithm to define the plurality of parameter combinations.

17. The non-transitory computer readable storage medium of claim 1, wherein the defining (D) is repeated until an exit condition is satisfied.

18. The non-transitory computer readable storage medium of claim 17, wherein the exit condition is user acceptance of the plurality of parameter combinations.

19. The non-transitory computer readable storage medium of claim 17, wherein the exit condition is satisfied when a power calculation based upon the plurality of parameter combinations satisfies a first threshold level.

20. The non-transitory computer readable storage medium of claim 1, wherein a first run constraint in the plurality of run constraints is an equality or inequality property imposed between the output of the parent node and the input of the child node in the parent node/child node pair associated with the first run constraint.

21. The non-transitory computer readable storage medium of claim 1, wherein a first run constraint in the plurality of run constraints is a mass balance inequality constraint between the output of the parent node and the input of the child node in the parent node/child node pair associated with the first run constraint.

22. The non-transitory computer readable storage medium of claim 1, wherein a first run constraint in the plurality of run constraints is a one-to-one, many-to-one, or one-to-many relationship between (i) the number of runs of the parent node and (ii) the number of runs for the child node for the corresponding parent node/child node pair.

23. The non-transitory computer readable storage medium of claim 1, the method further comprising adding runs to the plurality of runs prior to the building F), wherein the adding comprises:
(i) obtaining a set of runs, wherein each run in the set of runs is associated with a respective node in the plurality of nodes;
(ii) joining a subset of runs in the set of runs, wherein each run in the subset of runs is linked to at least one other run in the subset of runs by a run edge included in or added to the plurality of run edges;
(iii) assigning each run in the subset of runs with the parameter combination identifier of a parameter combination in the plurality of parameter combinations when the subset of runs includes a respective run for each respective factor in the plurality of factors at the respective level specified in the parameter combination for the respective factor;
(iv) removing the subset of runs from the set of runs;
(v) repeating the obtaining (i), joining (ii), assigning (iii) and removing (iv) until an exit condition is achieved; and
(vi) adding each run that has been assigned a parameter combination identifier in the assigning (iii) to the plurality of runs.

24. The non-transitory computer readable storage medium of claim 23, wherein each run in the set of runs specifies a level for a factor for the respective node corresponding to the factor.

25. The non-transitory computer readable storage medium of claim 23, wherein the set of runs are created by a user.

26. The non-transitory computer readable storage medium of claim 23, wherein the exit condition is depletion of the set of runs.

27. The non-transitory computer readable storage medium of claim 1, the method further comprising adding runs to the plurality of runs prior to the building F), wherein the adding comprises:
(i) obtaining a set of runs, wherein each run in the set of runs is associated with a respective node in the plurality of nodes;
(ii) joining a subset of runs in the set of runs, wherein each run in the subset of runs is linked to at least one other run in the subset of runs by a run edge included in or added to the plurality of run edges;
(iii) removing the subset of runs from the set of runs;
(iv) repeating the obtaining (i), joining (ii), and assigning (iii) until an exit condition is achieved, thereby achieving a plurality of subsets of runs;
(v) co-clustering each subset of runs in the plurality of subsets of runs that includes a run for each factor in the plurality of factors with the plurality of parameter combinations, wherein the co-clustering produces a plurality of clusters, wherein each cluster in the plurality of clusters includes at most one parameter combinations in the plurality of parameter combinations; and
(vi) assigning each run in the plurality of subsets of runs that co-clusters with a respective parameter combination the parameter combination identifier assigned to the respective co-clustered parameter combination; and
(vii) adding each run that has been assigned a parameter combination identifier in the assigning (vi) to the plurality of runs.

28. The non-transitory computer readable storage medium of claim 27, wherein each run in the set of runs specifies a level for a factor for the respective node corresponding to the factor.

29. The non-transitory computer readable storage medium of claim 27, wherein the set of runs are created by a user.

30. The non-transitory computer readable storage medium of claim 27, wherein the co-clustering is performed by k-means clustering or hierarchical clustering based on a distance metric.

31. The non-transitory computer readable storage medium of claim 30, wherein the distance metric is a Euclidian distance metric, a Hamming distance metric, or a correlation.

32. The non-transitory computer readable storage medium of claim 1, the method further comprising pruning the plurality of runs by counting a number of runs at each node in the plurality of nodes that have the same assigned parameter combination identifier.

33. A computer system, comprising:
one or more processors;
memory; and
one or more programs for building a run hypergraph from a plurality of parameter combinations for a process subject to a plurality of run constraints for the process, wherein,
the run hypergraph comprises (i) a plurality of nodes, (ii) a plurality of runs, each respective run in the plurality of runs being associated with a node in the plurality of nodes, and (iii) a plurality of run edges,
each run edge joins (a) a run in the plurality of runs associated with a parent node in the plurality of nodes and (b) a run in the plurality of runs associated with a child node in the plurality of nodes,
the process results in a respective product or analytical information, and
the one or more programs stored in the memory for execution by the one or more processors, comprise instructions for:
(A) obtaining a process hypergraph for the process, the process hypergraph comprising the plurality of nodes connected by process edges in a plurality of process edges, wherein
each respective node in the plurality of nodes is associated with:
(i) a set of parameterized resource inputs to the respective node, wherein at least one parameterized resource input in the set of parameterized resource inputs is associated with one or more input properties, the one or more input properties including an input specification limit, and
(ii) a set of parameterized resource outputs to the respective node, wherein at least one parameterized resource output in the set of parameterized resource outputs is associated with one or more output properties, the one or more output properties including a corresponding output specification limit, and
each respective process edge in the plurality of process edges specifies the set of parameterized resource outputs of a node (parent node) in the plurality of nodes that is included in the set of parameterized resource inputs of at least one other node (child node) in the plurality of nodes and identifies the at least one other node;
(B) identifying a plurality of factors, wherein each respective factor in the plurality of factors is associated with:
(i) an input property in the one or more input properties of a resource input in the set of parameterized resource inputs of a corresponding node in the plurality of nodes, or
(ii) an output property in the one or more output properties of a resource output in the set of parameterized resource outputs of a corresponding node in the plurality of nodes;
(C) identifying, for each respective factor in the plurality of factors, a number of levels for the input property or output property associated with the respective factor;
(D) defining the plurality of parameter combinations, wherein each parameter combination in the plurality of parameter combinations is:
(i) assigned a unique parameter combination identifier from a plurality of unique parameter combinations identifiers, and
(ii) includes an instance of each factor in the plurality of factors, wherein each respective factor in the instance of the plurality of factors is set to a level in the number of levels of the property associated with the respective factor;
(E) obtaining the plurality of run constraints, wherein
each respective run constraint in the plurality of run constraints corresponds to a different parent node/child node pair in the plurality of nodes that are connected by a process edge in the plurality of process edges, and
each respective run constraint in the plurality of run constraints specifies a relationship between a number of runs of the parent node to a number of runs for the child node for the corresponding parent node/child node pair;
(F) building the run hypergraph, wherein each respective run in the plurality of runs comprises: (i) an index to a corresponding node in the plurality of nodes, (ii) a run identifier, and (iii) a parameter combination identifier of a parameter combination in the plurality of parameter combinations.
